(19) United States
(12) Patent Application Publication
(10) Pub. No.: US 2016/0080806 A1
(43) Pub. Date: Mar. 17, 2016

(54) DEVICE STATE CHECKING SYSTEM, DEVICE STATE CHECKING METHOD, SERVER DEVICE, COMMUNICATION TERMINAL DEVICE, AND COMPUTER PROGRAM

(71) Applicant: SHARP CORPORATION, Osaka (JP)

(72) Inventor: Tomohiko OZEKI, Osaka-shi (JP)

(73) Assignee: SHARP CORPORATION, Osaka-shi, Osaka (JP)

(21) Appl. No.: 14/786,875

(22) PCT Filed: Apr. 18, 2014
(86) PCT No.: PCT/JP2014/061060

§ 371 Date: Oct. 23, 2015

(30) Foreign Application Priority Data
Apr. 26, 2013 (JP) 2013-093910
Apr. 26, 2013 (JP) 2013/093911

(51) Int. Cl. H04N 21/442; H04H 60/33; H04H 60/32; H04N 21/258; H04N 21/41

(52) U.S. Cl. CPC H04N 21/44222; H04N 21/25808; H04N 21/4126; H04H 60/32; H04N 21/44218; H04H 60/33

(57) ABSTRACT

[Object] To allow a server to check a change in a device state via a communication terminal device even in the case where a display device does not include a function of detecting its device state that changes in response to a user operation and of making a notification.

[Solution] A communication terminal device 20 capable of communicating with a server device 2 via a network NW is connected to a television device 10 by HDMI. The server device 2 stores a detection setting table in which information indicating a detection setting used in a detection process is associated with corresponding device identification information. The server device 2 identifies, in the detection setting table, detection setting information associated with device identification information output from the television device 10. The communication terminal device 20 detects the state of the television device 10 in accordance with the identified detection setting information on the basis of an output signal of the television device 10 and transmits the detection result to the server device 2 via the network NW.

### TECHNICAL FIELD

The present invention relates to a device state checking system, a device state checking method, a server device, a communication terminal device, and a computer program that make it possible to detect the state of a display device, such as a television device or computer display device used by a user.

### BACKGROUND ART

Various services have been provided that enable detection of the state of a television device used (operated) by a user every day (such as a state where a power-on operation has been performed by a user or a state where a power-off operation has been performed by a user) and enable utilization of the detection result.

For example, PTL 1 describes a watch-over service that makes it possible to remotely check whether something is wrong with a person such as an elderly person living alone by enabling transmission of a result of detecting the state of a television device on the basis of a user operation to a server. In addition, PTL 2 describes a service that makes it possible to investigate the ratings for a program, without installing any special devices or the like, by enabling transmission of a result of detecting a power-on or power-off state of a television device on the basis of a user operation to a rating company.

### CITATION LIST

### Patent Literature

PTL 1: Japanese Unexamined Patent Application Publication No. 2011-227699

PTL 2: Japanese Unexamined Patent Application Publication No. 2012-105353

### SUMMARY OF INVENTION

### Technical Problem

Television devices used in PTL 1 and PTL 2 described above are required to perform special processes, such as detecting their state that changes in response to a user operation and transmitting the detection result to a notification destination, as well as processes for typical television functions. However, typical television devices not having such special functions are incapable of detecting their state in the first place. Thus, typical television devices are not applicable to various services that utilize the detection result.

In addition, television devices are typically capable of outputting to the outside, in response to a user performing a power-on or power-off operation, information corresponding to such an operation. Information that is output in this manner is not standardized in terms of the signal format or contents and varies from manufacturer to manufacturer and from model to model, for example. For this reason, it is difficult to uniformly determine at the outside, for example, whether the television device is in a power-on state or power-off state on the basis of information output from the television device to the outside. Such an issue similarly occurs in display devices other than television devices, such as display devices used as monitors of personal computers.

The present invention has been made in view of such circumstances and aims to provide a device state checking system, a device state checking method, a server device, a communication terminal device, and a computer program that make it possible to apply, even if manufactures and models of display devices not having functions such as a detection function vary, the display devices to various services in which a communication terminal device connectable to the display devices or a server device detects the state of the devices and the detection result concerning the state of the devices is utilized, by preparing a table that stores contents of detection settings for the respective manufacturers and models of the display devices.

The present invention aims to provide a communication terminal device, a device state checking system, a device state checking method, and a computer program that make it possible to apply, even if display devices do not have special functions such as a function of detecting the state of the devices that changes in response to a user operation, by using a communication terminal device connectable to the display devices, the display devices to various services in which the communication terminal device or a server detects the state of the devices and the detection result concerning the state of the devices is utilized.

The present invention also aims to provide a device state checking system, a device state checking method, server device, a communication terminal device, and a computer program that make it possible to detect the state of the device by using an external connection unit/communication unit of various standards included in display devices.

The present invention aims to provide a communication terminal device, a device state checking system, a device state checking method, and a computer program that allow a communication terminal device or server to reliably detect the state of various kinds of display devices, by preparing a table that stores contents of detection settings for respective models of the display devices.

### Solution to Problem

To overcome the issues described above, a device state checking system according to the present invention includes a server device and a communication terminal device. The device state checking system allows a state of an external display device connectable to the communication terminal device to be checked. The communication terminal device includes means for obtaining, from the external display device, device identification information for identifying the external display device; and means for performing a process of transmitting the obtained device identification information to the server device. The server device includes a detection setting table that stores, for each of a plurality of display devices, device identification information of the display device in association with detection setting information related to detection of a state of the display device on the basis of an output from the display device; means for identifying, in a case where the device identification information transmitted from the communication terminal device is received, detection setting information associated with the received device identification information in the detection setting table; and means for performing a process of transmitting the identified detection setting information to the communication terminal device. The communication terminal device further includes means for detecting, in a case where the detection setting information transmitted from the server device is received, the state of the external display device in accordance with the received detection setting information on the basis of an output obtained from the external display device.

A device state checking system according to the present invention allows a server device capable of communicating with a communication terminal device connectable to an external display device to check a state of the external display device. The communication terminal device includes means for obtaining, from the external display device, device identification information for identifying the external display device; means for performing a process of transmitting the obtained device identification information to the server device; means for obtaining an output from the external display device; and means for performing a process of transmitting the obtained output to the server device. The server device includes a detection setting table that stores, for each of a plurality of display devices, device identification information of the display device in association with detection setting information related to detection of a state of the display device on the basis of an output from the display device; means for identifying, in a case where the device identification information transmitted from the communication terminal device is received, detection setting information associated with the received device identification information in the detection setting table; and means for detecting, in a case where the output transmitted from the communication terminal device is received, the state of the external display device in accordance with the identified detection setting information on the basis of the received output.

A device state checking method according to the present invention is a method for checking, by a server device and a communication terminal device, a state of an external display device connectable to the communication terminal device. The server device includes a detection setting table that stores, for each of a plurality of display devices, device identification information of the display device in association with detection setting information related to detection of a state of the display device on the basis of an output from the display device. The device state checking method includes a step of obtaining, by the communication terminal device, from the external display device, device identification information for identifying the external display device; a step of performing, by the communication terminal device, a process of transmitting the obtained device identification information to the server device; a step of identifying, by the server device, in a case where the device identification information transmitted from the communication terminal device is received, detection setting information associated with the received device identification information in the detection setting table; a step of performing, by the server device, a process of transmitting the identified detection setting information to the communication terminal device; and a step of detecting, by the communication terminal device, in a case where the detection setting information transmitted from the server device is received, the state of the external display device in accordance with the received detection setting information on the basis of an output obtained from the external display device.

A device state checking method according to the present invention is a method for allowing a server device to communicate with a communication terminal device connectable to an external display device and to check a state of the external display device. The server device includes a detection setting table that stores, for each of a plurality of display devices, device identification information of the display device in association with detection setting information related to detection of a state of the display device on the basis of an output from the display device. The device state checking method includes a step of obtaining, by the communication terminal device, from the external display device, device identification information for identifying the external display device; a step of performing, by the communication terminal device, a process of transmitting the obtained device identification information to the server device; a step of obtaining, by the communication terminal device, an output from the external display device; a step of performing, by the communication terminal device, a process of transmitting the obtained output to the server device; a step of identifying, by the server device, in a case where the device identification information transmitted from the communication terminal device is received, detection setting information associated with the received device identification information in the detection setting table; and a step of detecting, by the server device, in a case where the output transmitted from the communication terminal device is received, the state of the external display device in accordance with the identified detection setting information on the basis of the received output.

A device state checking method according to the present invention is a method for allowing a communication terminal device to check a state of an external display device. The communication terminal device includes connection means connectable to the external display device, and communication means capable of performing communication via a network. The device state checking method includes a step of obtaining, from the external display device via the connection means, device identification information for identifying the external display device; a step of performing a process of transmitting, via the communication means, the obtained device identification information to a destination for which an inquiry about detection setting information is made; and a step of detecting, in a case where the detection setting information is received via the communication means in response to the process of transmitting the device identification information, the state of the external display device in accordance with the received detection setting information on the basis of an output obtained from the external display device via the connection means.

A device state checking method according to the present invention is a method for allowing a communication terminal device to check a state of an external display device. The communication terminal device includes connection means connectable to the external display device, communication means capable of performing communication via a network, and a detection setting table that stores, for each of a plurality of display devices, device identification information of the display device in association with detection setting information related to detection of a state of the display device on the basis of an output from the display device. The device state checking method includes a step of obtaining, from the external display device via the connection means, device identification information for identifying the external display device; a step of identifying detection setting information associated with the obtained device identification information in the detection setting table; and a step of detecting the state of the external display device in accordance with the identified detection setting information on the basis of an output obtained from the external display device via the connection means.

A server device according to the present invention capable of checking a state of an external display device by performing communication via a network, includes a detection setting table that stores, for each of a plurality of display devices, device identification information of the display device in association with detection setting information related to detection of a state of the display device on the basis of an output from the display device; means for performing a process of receiving device identification information for identifying the external display device; setting identifying means for identifying, in a case where the device identification information is received, detection setting information associated with the received device identification information in the detection setting table; means for performing a process of transmitting the identified detection setting information to a transmission source of the device identification information; means for performing, in response to transmission of the device identification information, a process of receiving a detection result obtained by detecting the state of the external display device; and means for performing, in a case where the detection result is received, a process of storing the received detection result in association with a date/time.

A server device according to the present invention capable of checking a state of an external display device by performing communication via a network, includes a detection setting table that stores, for each of a plurality of display devices, device identification information of the display device in association with detection setting information related to detection of a state of the display device on the basis of an output from the display device; means for performing a process of receiving device identification information for identifying the external display device; setting identifying means for identifying, in a case where the device identification information is received, detection setting information associated with the received device identification information in the detection setting table; and means for detecting, in a case where an output from the external display device is received, the state of the external display device in accordance with the identified detection setting information on the basis of the received output.

In the server device according to the present invention, a plurality of kinds of detection setting information are associated with each piece of device identification information in the detection setting table.

In the server device according to the present invention, the setting identifying means identifies the detection setting information from among the plurality of kinds of detection setting information in accordance with a predetermined priority order.

In the server device according to the present invention, the plurality of kinds of detection setting information are pieces of information corresponding to a plurality of kinds of connections or communication schemes.

A communication terminal device according to the present invention including connection means connectable to an external display device, and communication means capable of performing communication via a network, includes means for obtaining, from the external display device via the connection means, device identification information for identifying the external display device; means for performing a process of transmitting, via the communication means, the obtained device identification information to a destination for which an inquiry about detection setting information is made; means for performing a process of receiving the detection setting information via the communication means in response to the process of transmitting the device identification information; output obtaining means for obtaining an output from the external display device via the connection means; and state detecting means for detecting a state of the external display device in accordance with the received detection setting information on the basis of the output obtained by the output obtaining means.

A communication terminal device according to the present invention including connection means connectable to an external display device, and communication means capable of performing communication via a network, includes a detection setting table that stores, for each of a plurality of display devices, device identification information of the display device in association with detection setting information related to detection of a state of the display device on the basis of an output from the display device; means for obtaining, from the external display device via the connection means, device identification information for identifying the external display device; setting identifying means for identifying detection setting information associated with the obtained device identification information in the detection setting table; output obtaining means for obtaining an output from the external display device via the connection means; and state detecting means for detecting a state of the external display device in accordance with the identified detection setting information on the basis of the output obtained by the output obtaining means.

The communication terminal device according to the present invention further includes means for performing a process of transmitting a detection result obtained by the state detecting means to an external notification destination via the communication means.

In the communication terminal device according to the present invention, the detection setting information is information that sets detection of the state of the external display device on the basis of content of an output message of the external display device, the output obtaining means obtains the output message from the external display device, and the state detecting means detects the state of the external display device on the basis of the content of the obtained output message.

In the communication terminal device according to the present invention, the detection setting information is information that sets detection of the state of the external display device on the basis of at least one of output information following a power-on operation on the external display device and output information following a power-off operation on the external display device; the output obtaining means obtains, from the external display device, at least one of the output information following a power-on operation on the external display device and the output information following a power-off operation on the external display device; and the state detecting means detects the state of the external display device in accordance with the detection setting information on the basis of the obtained output information.

A computer program according to the present invention is a computer program causing a server computer to perform a process of checking a state of an external display device. The server computer includes communication means for performing communication via a network, and a detection setting table that stores, for each of a plurality of display devices, device identification information of the display device in association with detection setting information related to detection of a state of the display device on the basis of an output from the display device. The computer program causes the server computer to function as means for performing a process of receiving, via the communication means, device identification information for identifying the external display device; means for performing a process of identifying, in a case where the device identification information is received, detection setting information associated with the received device identification information in the detection setting table; means for performing a process of transmitting the identified detection setting information to a transmission source of the device identification information via the communication means; means for performing, in response to transmission of the device identification information, a process of receiving, via the communication means, a detection result obtained by detecting the state of the external display device; and means for performing, in a case where the detection result is received, a process of storing the received detection result in association with a date/time.

A computer program according to the present invention is a computer program causing a computer to perform a process of checking a state of an external display device. The computer includes connection means connectable to the external display device, and communication means for performing communication via a network. The computer program causes the computer to function as means for performing a process of obtaining, from the external display device via the connection means, device identification information for identifying the external display device; means for performing a process of transmitting, via the communication means, the obtained device identification information to a destination for which an inquiry about detection setting information is made; means for performing a process of receiving the detection setting information via the communication means in response to the process of transmitting the device identification information; output obtaining means for obtaining an output from the external display device via the connection means; and means for performing a process of detecting the state of the external display device in accordance with the received detection setting information on the basis of the output obtained by the output obtaining means.

In the present invention, a detection setting table in which detection setting information that defines how to detect a state of a display device is associated with corresponding device identification information for identifying the display device is prepared in a server device. A communication terminal device connected to an external display device transmits device identification information of the external display device to the server device and obtains detection setting information associated with the device identification information. Accordingly, the state of the display device can be detected by the communication terminal device regardless of the manufacturer/model of the external display device.

In the present invention, a server device prepares a detection setting table in which detection setting information that defines how to detect a state of a display device is associated with corresponding device identification information for identifying the display device. Device identification information of an external display device is transmitted from a communication terminal device connected to the external display device. In this way, the server device identifies detection setting information associated with the device identification information in the detection setting table and then receives an output of the external display device that is transmitted from the communication terminal device. Accordingly, the state of the display device can be detected by the server device regardless of the manufacturer/model of the external display device.

In the present invention, a communication terminal device connected to an external display device prepares a detection setting table in which detection setting information that defines how to detect a state of a display device is associated with corresponding device identification information for identifying the display device. The communication terminal device identifies detection setting information from device identification information of an external display device serving as its connection destination and detects the state of the device by using the identified detection setting information. Accordingly, the state of the display device can be detected by the communication terminal device regardless of the manufacturer/model of the external display device. In addition, since communication with the server device is not performed, a detection process can be performed speedily.

In the present invention, in the case where the communication terminal device detects the state of the device, the communication terminal device transmits the detection result to the server device. Accordingly, the detection result can be checked by the server device and can be utilized in a wide variety of applications.

In the present invention, a plurality of kinds of detection setting information are associated with corresponding device identification information in a detection setting table. Thus, a wide variety of models can be subjected to detection.

In the present invention, detection setting information used in detection is identified from among the plurality of kinds of detection setting information in accordance with a predetermined priority order. Accordingly, the detection setting information can be identified smoothly. In addition, when the priority order is determined on the basis of the ease of detection, the reliability of detection, or the like, the efficiency of the detection process and the accuracy of the detection result can be improved.

In the present invention, the plurality of kinds of detection setting information are pieces of information based on a plurality of kinds of connections or communication schemes. Accordingly, various detection methods can be employed, and the detection process can be flexibly performed in accordance with the configurations of the device, the installation state, or the like.

In the present invention, detection is performed by using detection setting information indicating detection of a state of an external display device on the basis of contents of an output message. Accordingly, the state of the external display device can be easily detected by checking the contents of the output message.

In the present invention, detection is performed by using detection setting information indicating detection of the state of the external display device on the basis of information following a power-on operation or information following a power-off operation. Accordingly, the state of the external display device can be detected at a timing corresponding to an actual user operation.

A communication terminal device according to the present invention including connection means connectable to an external display device, and communication means capable of performing communication via a network, includes information obtaining means for obtaining, from the external display device via the connection means, at least one of output information following a power-on operation on the external display device and output information following a power-off operation on the external display device; and detection setup means for performing a process of identifying a detection setting used in detection from among a plurality of detection settings for detecting a state of the external display device on the basis of the output information obtained by the information obtaining means.

The communication terminal device according to the present invention further includes state detecting means for detecting the state of the external display device in accordance with the detection setting identified in the process by the detection setup means, on the basis of the output information obtained by the information obtaining means; and means for performing a process of transmitting a detection result obtained by the state detecting means to an external notification destination via the communication means.

The communication terminal device according to the present invention further includes storage means for storing screen information corresponding to screen content displayable on the external display device; and means for performing a process of reading the screen information stored in the storage means and outputting the screen information via the connection means. The storage means stores user instruction screen information corresponding to screen content including an instruction that prompts a user to perform a power-off operation and perform a power-on operation after a certain amount of time from the power-off operation. The detection setup means performs the process of identifying the detection setting in a case where the user instruction screen information is output.

The communication terminal device according to the present invention further includes means for obtaining, from the external display device via the connection means, at least one of an output message indicating that a power-on operation has been performed on the external display device, an output message indicating that a power-off operation has been performed on the external display device, and an output message indicating that an input switching operation has been performed on the external display device. The detection setup means performs the process of identifying the detection setting in a case where none of the output messages are obtained.

In the communication terminal device according to the present invention, the state detecting means detects, in a case where any of the output messages is obtained, the state of the external display device on the basis of the obtained output message.

The communication terminal device according to the present invention further includes means for outputting a message request via the connection means. The detection setup means performs the process of identifying the detection setting in a case where no response message is obtained via the connection means in response to the message request.

A communication terminal device according to the present invention including communication means capable of communicating with an external display device and an external notification destination, includes means for receiving and obtaining, from the external display device via the communication means, output information indicating establishment of a communication connection to the external display device; state detecting means for detecting whether the external display device is in a power-on state or a power-off state depending on whether the output information is obtained; and means for performing a process of transmitting a detection result obtained by the state detecting means to the external notification destination via the communication means.

A communication terminal device according to the present invention including connection means connectable to an external display device, and communication means capable of performing communication via a network, includes means for obtaining, from the external display device via the connection means, output information indicating establishment of a connection to the external display device; state detecting means for detecting whether the external display device is in a power-on state or a power-off state depending on whether the output information is obtained; and means for performing a process of transmitting a detection result obtained by the state detecting means to an external notification destination via the communication means.

A device state checking system according to the present invention includes a communication terminal device connectable to an external display device, and a server capable of communicating with the communication terminal device via a network. The device state checking system allows the server to check a state of the external display device on the basis of a notification from the communication terminal device. The communication terminal device is any one of the communication terminal devices described above and transmits the detection result obtained by the state detecting means to the server via the communication means. The server stores the received detection result in association with a reception date/time.

A device state checking method according to the present invention for checking a state of an external reception device by receiving a state of an external display device, includes a step of obtaining, from the external display device, at least one of output information that is output in response to a power-on operation on the external display device and output information that is output in response to a power-off operation on the external display device from the external display device; a step of performing a process of identifying a detection setting used in detection from among a plurality of detection settings for detecting the state of the external display device on the basis of the obtained output information; and a step of detecting the state of the external display device in accordance with the identified detection setting on the basis of the obtained output information.

A computer program according to the present invention is a computer program causing a computer to be able to detect a state of an external display device. The computer includes connection means connectable to the external display device, and communication means capable of performing communication via a network. The computer program causes the computer to function as means for performing a process of obtaining, from the external display device via the connection means, at least one of output information that is output in response to a power-on operation on the external display device and output information that is output in response to a power-off operation on the external display device; and means for performing a process of identifying a detection setting used in detection from among a plurality of detection settings for detecting the state of the external display device on the basis of the obtained output information.

A computer program according to the present invention is a computer program causing a computer including communication means capable of communicating with an external display device and an external notification destination to perform a process of notifying the external notification destination of a state of the external display device. The computer program causes the computer to function as means for performing a process of receiving and obtaining, from the external display device via the communication means, output information indicating establishment of a communication connection to the external display device; means for performing a process of detecting whether the external display device is in a power-on state or a power-off state depending on whether the output information is obtained; and means for performing a process of transmitting a detection result to the external notification destination via the communication means.

A computer program according to the present invention is a computer program causing a computer including connection means connectable to an external display device and communication means capable of performing communication via a network to perform a process of notifying an external notification destination of a state of the external display device. The computer program causes the computer to function as means for performing a process of obtaining, from the external display device via the connection means, output information indicating establishment of a connection to the external display device; means for performing a process of detecting whether the external display device is in a power-on state or a power-off state depending on whether the output information is obtained; and means for performing a process of transmitting a detection result to the external notification destination via the communication means.

In the present invention, a communication terminal device connectable to a display device is used. In addition, the communication terminal device obtains at least one of output information following a power-on operation on an external display device and output information following a power-off operation on the external display device and identifies a detection setting used in detection from among a plurality of detection settings for detecting a state of the external display device on the basis of the obtained output information. Accordingly, the setting for detecting the external display device can be settled, and detection can be performed even if the display device does not include a function of detecting its state.

In the present invention, the communication terminal device transmits a result of performing detection in accordance with the identified detection setting to an external notification destination. Accordingly, the state of the display device used by the user can be remotely checked, and the detected state of the device can be utilized in various services.

In the present invention, an instruction that prompts the user to perform a power-off operation and perform a power-on operation after a certain amount of time from the power-off operation is displayed on the display device. Accordingly, the communication terminal device can reliably obtain output information that is output in response to the power-off operation and output information that is output in response to the power-on operation, making detection setup easier.

In the present invention, detection setup is performed based on output information in the case where an output message indicating a state of the display device is not obtainable. Accordingly, detection setup can be performed flexibly for various output configurations of the display device.

In the present invention, in the case where an output message indicating the state of the display device is obtainable, the state of the device is detected on the basis of the output message. Accordingly, the state of the device can be easily and reliably detected.

Even in the case where an output message is obtainable from the display device, the output message may no longer output from the display device because of a setting change made in the display device later. Thus, in the present invention, a message request is output to the display device, and a state where the display device does not output an output message and a state where an output message is no longer output due to a setting change can be discriminated from each other depending on whether a response message is obtainable in response to the message request.

In addition, in the present invention, the state of the external display device is detected by using an output indicating establishment of a communication connection to the external display device. Accordingly, the state of the device can be detected even in the case where the state of the device is not detectable with an output message or the like. Further, such detection can be performed via communication or connection to the display device. Accordingly, the state of the device can be detected by using various interface standards.

### Advantageous Effects of Invention

In the present invention, a communication terminal device performs a detection process after downloading detection setting information associated with device identification information of an external display device from a server device in which a detection setting table is prepared. Thus, the detection process can be performed by the communication terminal device regardless of the manufacturer/model of the external display device.

In the present invention, a server device in which a detection setting table is prepared performs a detection process on the basis of an output of an external display device that is transmitted from a communication terminal device. Thus, the detection process can be performed by the server device regardless of the manufacturer/model of the external display device.

In the present invention, a communication terminal device connected to an external display device prepares a detection setting table and directly performs a detection process. Thus, the state of the display device can be detected by the communication terminal device regardless of the manufacturer/model of the external display device, and the detection process can be performed speedily without communication with the server device.

In the present invention, in the case where the communication terminal device detects the state of the device, the communication terminal device transmits the detection result to the server device. Thus, the server device can check the detection result, making it easier to utilize the detection result in a wide variety of services.

In the present invention, since a plurality of kinds of detection setting information are associated with corresponding device identification information in the detection setting table, detection of various models can be implemented.

In the present invention, detection setting information used in detection is identified from among the plurality of kinds of detection setting information in accordance with a predetermined priority order. Thus, the efficiency of the detection process and the accuracy of the detection result are improved.

In the present invention, information indicating a setting of using an output message of an external device is used as the detection setting information. Thus, the state of the external display device can be easily and reliably detected by checking contents of the output message.

In the present invention, detection setting information indicating detection of the state of the external display device on the basis of information following a power-on operation or information following a power-off operation is used. Thus, the detection process can be performed in response to an actual user operation status.

In the present invention, a communication terminal device connectable to a display device is used. The communication terminal device obtains output information that is output in response to a power-on/off operation on an external display device and identifies a detection setting used in detection from among a plurality of detection settings for detecting the state of the external display device on the basis of the obtained output information. Thus, a setting necessary for detecting the external display device can be settled, and the state of the device can be detected even in the case where the display device does not include a function of detecting its state.

In the present invention, the communication terminal device transmits the detection result to an external notification destination. Thus, the state of the display device used by the user can be remotely checked, and even a display device not including a function of detecting its state can be used in various services that utilize the device state detection result.

In the present invention, an instruction that prompts a user to perform a power-off operation and perform a power-on operation after a certain amount of time from the power-off operation is displayed on the display device. Thus, the communication terminal device can reliably obtain output information that is output in response to a power-off operation and output information that is output in response to a power-on operation and can reliably identify a detection setting based on the output information.

In the present invention, detection setup is performed on the basis of output information even in the case where an output message indicating the state of the display device is not obtainable. Thus, detection setup can be performed flexibly for various output configurations of the display device.

In the present invention, in the case where an output message indicating the state of the display device is obtainable, the state of the device is detected on the basis of the output message. Thus, the state of the device can be easily and reliably detected.

In the present invention, if a message is not output in the case where the display device is configured to output a message, the state where the display device just does not output an output message and the state where the output message is no longer output due to a setting change can be discriminated from each other depending on whether a response message is obtained in response to a message request.

In addition, in the present invention, the state of the external display device is detected by using output information indicating establishment of a communication connection to the external display device. Thus, the state of the device can be detected even in the case where the state of the device is not detectable with an output message or the like. Further, such detection can be performed via communication or connection with the display device. Thus, the state of the device can be detected by using various interface standards.

### BRIEF DESCRIPTION OF DRAWINGS

FIG. 1 is a schematic diagram illustrating an overview of a watch-over service implemented by using a device state checking system according to a first embodiment of the present invention.

FIG. 2 is a schematic diagram illustrating major components of the device state checking system.

FIG. 3 is a block diagram illustrating major internal components of a television device.

FIG. 4 is a schematic diagram illustrating an overview of a remote control.

FIG. 5 is a schematic diagram illustrating an overview of a source switching menu screen.

FIG. 6 Part (a) is a schematic diagram illustrating an external appearance of a communication terminal device, and part (b) is a block diagram illustrating major internal components of the communication terminal device.

FIG. 7 Part (a) is a schematic diagram illustrating a home screen, part (b) is a schematic diagram illustrating a setup screen, and part (c) is a schematic diagram illustrating a user instruction screen.

FIG. 8 Part (a) is a schematic diagram illustrating an on/off setup completion screen, part (b) is a schematic diagram illustrating an on/off setup failure screen, and part (c) is a schematic diagram illustrating an on/off setup impossible screen.

FIG. 9 is a block diagram illustrating major internal components of a server device.

FIG. 10 is a diagram illustrating an example of a user DB (database).

FIG. 11 is a schematic diagram illustrating an example of contents of a storage table that stores detection results.

FIG. 12 is a first flowchart illustrating a procedure of a device state checking method according to the first embodiment.

FIG. 13 is a second flowchart illustrating a procedure of the device state checking method according to the first embodiment.

FIG. 14 is a third flowchart illustrating a procedure of a device state checking method according to a second embodiment.

FIG. 15 Part (a) is a schematic diagram illustrating an example of a home screen according to the second embodiment, and part (b) is a schematic diagram illustrating another example of the home screen according to the second embodiment.

FIG. 16 is a fourth flowchart illustrating a procedure of a device state checking method according to a third embodiment.

FIG. 17 is a diagram illustrating an example of a detection setting table.

FIG. 18 is a fifth flowchart illustrating a procedure of a device state checking method according to a fourth embodiment.

FIG. 19 is a sixth flowchart illustrating a procedure of the device state checking method according to a modification of the fourth embodiment.

FIG. 20 is a seventh flowchart illustrating a procedure of a device state checking method according to a fifth embodiment.

FIG. 21 is an eighth flowchart illustrating a procedure of a device state checking method according to a sixth embodiment.

FIG. 22 is a ninth flowchart illustrating a procedure of the device state checking method according to the sixth embodiment.

FIG. 23 is a tenth flowchart illustrating a procedure of the device state checking method according to the sixth embodiment.

FIG. 24 is an eleventh flowchart illustrating a procedure of a device state checking method according to a seventh embodiment.

FIG. 25 is a twelfth flowchart illustrating a procedure of the device state checking method according to the seventh embodiment.

FIG. 26 is a thirteenth flowchart illustrating a procedure of a device state checking method according to an eighth embodiment.

FIG. 27 is a diagram illustrating an example of a detection setting table used in a modification of the eighth embodiment.

FIG. 28 is a fourteenth flowchart illustrating a procedure of a device state checking method according to a ninth embodiment.

FIG. 29 is a diagram illustrating an example of a detection setting table used in a modification of the ninth embodiment.

FIG. 30 is a fifteenth flowchart illustrating a procedure of a device state checking method according to a tenth embodiment.

FIG. 31 is a diagram illustrating an example of a detection setting table used in a modification of the tenth embodiment.

### DESCRIPTION OF EMBODIMENTS

### First Embodiment

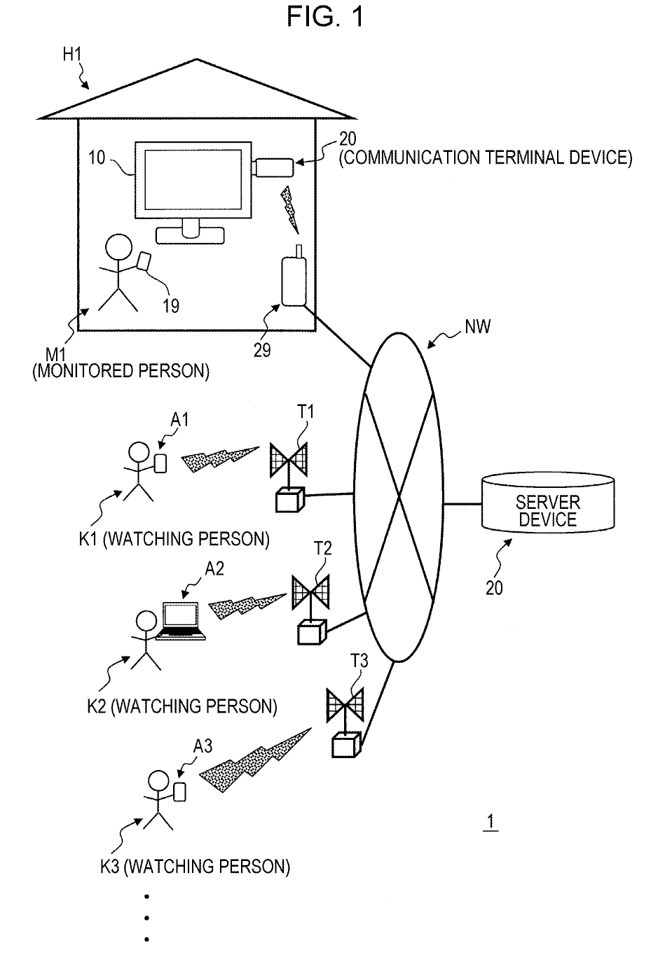

FIG. 1 illustrates an overview of the case where a device state checking system 1 according to a first embodiment of the present invention is used for a watch-over service. The watch-over service illustrated in FIG. 1 makes it possible to remotely monitor whether something is wrong with a person (a monitored person M1 to be monitored) who lives in a house H1 by enabling detection of the state of a television device 10 used by the monitored person M1 and transmission of the detection result to a server device 2.

In the device state checking system 1, a communication terminal device 20 is connected to the television device 10 (corresponding to an external display device) that is operated by a user (the monitored person M1). This communication terminal device 20 obtains, from the television device 10, an output that is based on a power-on operation or a power-off operation performed on the television device 10 by the user; detects whether the television device 10 is in a power-on state or a power-off state on the basis of contents of the obtained output; and transmits the detection result to the server device 2. The server device 2 stores the detection result transmitted thereto, in association with a reception date/time and determines whether something is wrong with the monitored person M1 on the basis of the stored contents. If the server device 2 determines that something is wrong, the server device 2 transmits an instruction to check the condition of the monitored person M1 to watching persons K1 to K2 who watch over the monitored person M1.

The communication terminal device 20 according to the embodiment wirelessly (using a wireless LAN) communicates with the server device 2 via a network NW. To enable such wireless communication, a wireless router 29 for wireless communication is installed in the house H1. In addition, the watching persons K1 to K3 respectively carry mobile communication terminals A1 to A3 to be able to receive an instruction from the server device 2. These communication terminal devices A1 to A3 are capable of communicating with the server device 2 or the like respectively via relay base stations T1 to T3 connected to the network NW. To simplify the illustrated contents, FIG. 1 illustrates only one watch-over group including, for example, one monitored person M1 and a plurality of watching persons K1 to K3; however, the watch-over service according to the present invention is obviously capable of handling a plurality of watch-over groups. The device state checking system 1 that forms a major part of the watch-over service illustrated in FIG. 1 will be described in detail below.

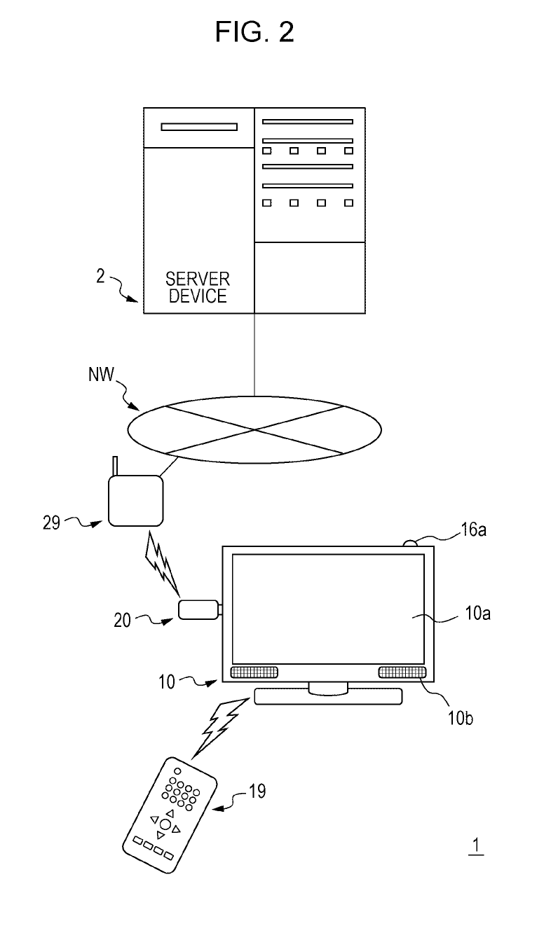

FIG. 2 illustrates major components of the device state checking system 1 according to the embodiment of the present invention. The server device 2 and the communication terminal device 20 are connected to be able to communicate with each other via the wireless router 29 and a communication media such as the network NW. In addition, the communication terminal device 20 is directly connected to the television device 10 on which various operations are performed by the user. The communication terminal device 20 is capable of presenting various kinds of screen information (screen contents) output therefrom to the user (the monitored person M1) by using a display function of the television device 10.

The television device 10, which serves as a target used (operated) by the user every day, includes a display screen 10a and speakers 10b on the front face of its casing and a power switch 16a on the casing. The television device 10 accepts various user operations with a remote control 19 in addition to an operation unit disposed on its device body.

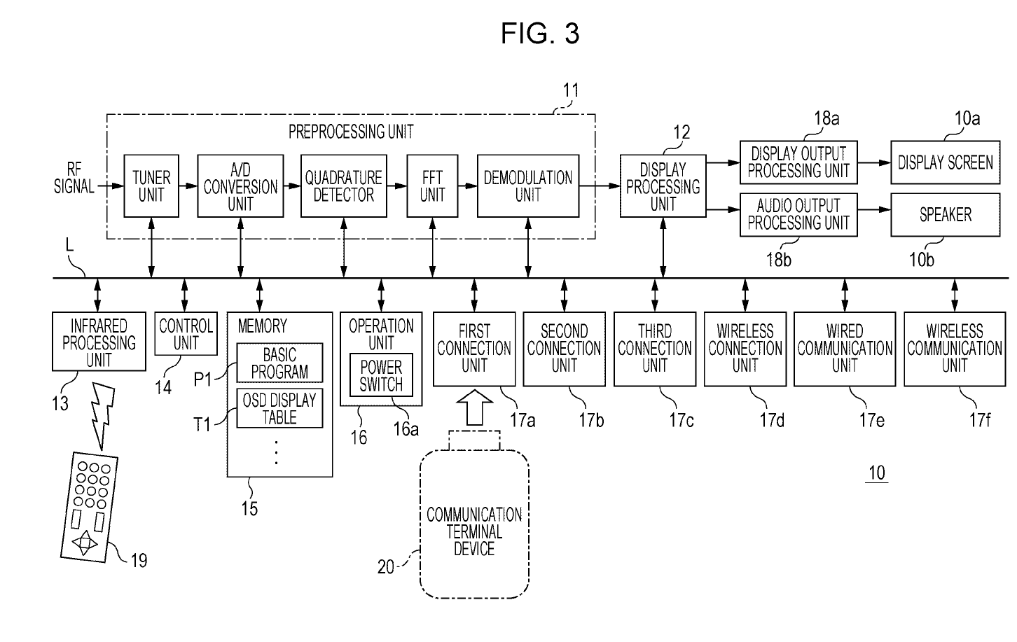

FIG. 3 illustrates an overview of major internal components of the television device 10. The television device 10 includes, for example, a preprocessing unit 11, a display processing unit 12, an infrared processing unit 13, a control unit 14, a memory 15, an operation unit 16, a first connection unit 17a, a second connection unit 17b, a third connection unit 17c, a wireless connection unit 17d, a wired communication unit 17e, a wireless communication unit 17f, a display output processing unit 18a, and an audio output processing unit 18b, which are connected to one another via an internal connection line L. Each of these units, such as the unit 11, transmits and receives a signal to and from the control unit 14 via the internal connection line L. Each of these units, such as the unit 11, transfers a signal indicating the current processing status or the like to the control unit 14. The control unit 14 grasps the current processing status on the basis of the processing status or the like transferred from each of the units, such as the unit 11, and transmits, to each of the units, such as the unit 11, a control signal for controlling a subsequent process in accordance with the grasped status. Each of the units of the television device 10 will be described below.

The preprocessing unit 11 includes a tuner unit, an A/D conversion unit, a quadrature detector, an FFT unit, and a demodulation unit. The preprocessing unit 11 is fed with an RF signal (digital broadcast signal) obtained with an antenna, performs a certain process on this input signal to obtain a demodulated transport stream (TS), and transfers the transport stream to the display processing unit 12 that performs a subsequent process. The display processing unit 12 performs a decoding process on the demodulated transport stream obtained by the preprocessing unit 11 to demultiplex the transport stream into video, audio, and other data. The display processing unit 12 performs a video decoding process on the obtained video stream and outputs the resulting stream to the display output processing unit 18a. The display processing unit 12 also performs an audio decoding process on the obtained audio stream and outputs the resulting stream to the audio output processing unit 18b. The display processing unit 12 also performs a process of demultiplexing content obtained from the first connection unit 17a, the second connection unit 17b, the third connection unit 17c, the wireless connection unit 17d, the wired communication unit 17e, and the wireless communication unit 17f into video (images), audio, and other data and outputting the resulting data to the display output processing unit 18a and the audio output processing unit 18b. Note that the display processing unit 12 appropriately switches between targets (sources) of the above-described display process in accordance with an instruction given by the control unit 14.

The display output processing unit 18a performs a certain process necessary for displaying an image to generate an image signal and outputs the generated image signal to the display screen 10a. In addition, the audio output processing unit 18b performs a certain process necessary for audio output, such as amplification, to generate an audio signal and outputs the generated audio signal to the speakers 10b so as to output various kinds of sound from the speakers 10c. As a result of the processes described above, images of a television broadcast program or the like are displayed on the display screen 10a if the source processed by the display processing unit 12 is set to a broadcast signal received by the turner unit. Alternatively, images based on a source obtained from the outside of the television device 10 are displayed on the display screen 10a if the source processed is set to an external signal obtained by any one of the first connection unit 17a, the second connection unit 17b, the third connection unit 17c, the wireless connection unit 17d, the wired communication unit 17e, and the wireless communication unit 17f.

In addition, the operation unit 16 and the infrared processing unit 13 are provided as parts related to a user interface of the television device 10. The operation unit 16 is a user interface provided on the casing of the television device 10 and includes buttons such as a volume changing button, a channel switching button, a source switching button, up and down keys, and an OK key as well as the power switch 16a for power on/off. Contents of an operation performed by the user are transferred to the control unit 14. The infrared processing unit 13 performs a communication process (signal/data transmission/reception process) according to a known infrared standard (e.g., each standard of the IrDA series). The infrared processing unit 13 basically performs a process of receiving operation-signal-containing infrared light emitted from the remote control 19, which accepts an operation from the user, and of transferring the operation signal to the control unit 14.

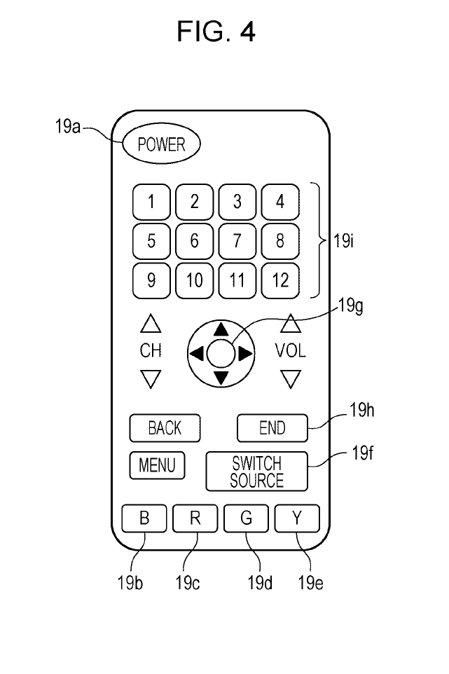

FIG. 4 illustrates the remote control 19 that emits infrared light toward the infrared processing unit 13 described above. The remote control 19 includes a power switch 19a for powering on/off the television device 10 at a top end portion thereof; numerical buttons 19i including twelve buttons in total; left, right, up, and down keys; an OK button 19g; a volume adjustment key; a channel switching key; a source switching button 19f; a back button; an end button 19h; a menu button; and four color buttons (i.e., a blue button 19b, a red button 19c, a green button 19d, and a yellow button 19e). Upon accepting an operation from the user with each of these buttons and switches, the remote control 19 emits infrared light indicating content of the accepted operation. Note that a power-on operation or a power-off operation is performed on the television device 10 in response to the user operating the power switch 16a of the above-described operation unit 16 or the power switch 19a of the remote control.

Note that a power-off operation in the present invention indicates an operation for changing the state of the television device 10 from a powered state to a so-called standby state (a state where only units of the television device 10 that perform a process related to reception of infrared light from the remote control 19, such as the infrared processing unit 13 and the control unit 14, are powered and the other units are not powered). This standby state is defined as a power-off state. A state where power supply to the television device 10 is completely stopped is defined as a complete power-off state. Since the control unit 14 is powered in the power-off state (the standby state), the control unit 14 is able to perform various processes based on control. In addition, a power-on operation in the present invention indicates an operation for changing the state of the television device 10 from the complete power-off state or the power-off state (the standby state) to the powered state in which the entire device is activated.

Referring back to FIG. 3, the description of the internal components of the television device 10 will be continued. The television device 10 includes a plurality of input lines for connections to external devices. These input lines include the first connection unit 17a, the second connection unit 17b, the third connection unit 17c, the wireless connection unit 17d, the wired communication unit 17e, and the wireless communication unit 17f.

The first connection unit 17a includes a connection terminal that is compliant with the HDMI (registered trademark) (High-Definition Multimedia Interface) standard, which is a communication interface standard for transmitting video, audio, and control signals as digital signals. The communication terminal device 20 of the embodiment can be directly connected to the first connection unit 17a. The second connection unit 17b includes a connection terminal that is compliant with the USB (Universal Serial Bus) standard, which is one of serial bus standards that enable serial connections of various peripheral devices. The third connection unit 17c includes a connection terminal that is compliant with a standard of the IEEE 1394 series. This third connection unit 17c corresponds to, for example, i.LINK (registered trademark) or a DV terminal.

The wireless connection unit 17d enables wireless connections to various peripheral devices. In the embodiment, the wireless connection unit 17d based on the Bluetooth (registered trademark) standard is used. The wired communication unit 17e enables wired communication via a network and includes a wired LAN connection terminal based on Ethernet (registered trademark) in the embodiment. The wireless communication unit 17f is a communication unit that enables wireless communication. In the embodiment, the wireless communication unit 17f performs wireless communication based on a standard of the IEEE 802.11 family (wireless LAN).

The control unit 14 plays a central role when various functions of the television device 10 are executed. The control unit 14 performs various processes (such as a television broadcast reception process, an OSD display process, an output process, and a communication process) on the basis of various processing contents defined by a basic program P1 stored in the memory 15. The memory 15 also stores an OSD display table T1 and the like, in addition to the aforementioned basic program P1. The OSD display table T1 stores various kinds of display image data corresponding to the menu screen and other screens subjected to OSD display.

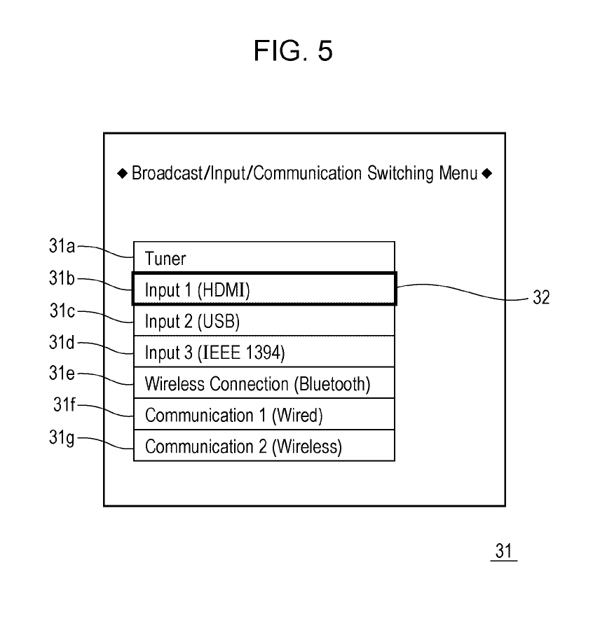

FIG. 5 illustrates a state where a source switching menu screen 31, which is based on one of a plurality of kinds of display screen data stored in the OSD display table T1, is displayed on the display screen 10a of the television device 10. This source switching menu screen 31 is a menu screen that allows the user to select a source to be displayed on the display screen 10a. The source switching menu screen 31 is output on the display screen 10a as a result of display screen data corresponding to the source switching menu screen 31 being read from the OSD display table T1 under control of the control unit 14 in response to an operation of pressing the source switching button 19f of the remote control 19. The source switching menu screen 31 includes a plurality of selection items, i.e., a first selection item 31a to a seventh selection item 31g, and a cursor 32 that enables selection of any one of the selection items 31a to 31g. The cursor 32 is movable with the up and down keys of the operation unit 16 or the remote control 19. By performing an operation of pressing the OK button, the selection item with the cursor 32 placed thereon is selected.

The first selection item 31a is an item for selecting a television broadcast received by the tuner unit of the preprocessing unit 11. Similarly, the second selection item 31b is for selecting an input from the first connection unit 17a (HDMI). The third selection item 31c is for selecting an input from the second connection unit 17b (USB). The fourth selection item 31d is for selecting an input from the third connection unit 17c (IEEE 1394). The fifth selection item 31e is for selecting an input from the wireless connection unit 17d (Bluetooth (registered trademark)). The sixth selection item 31f is for selecting an input from the wired communication unit 17e (wired LAN). The seventh selection item 31g is for selecting an input from the wireless communication unit 17f (wireless LAN).

The basic program P1 stored in the memory 15 corresponds to firmware and a system program or the like of the television device 10 and defines various processes performed by the control unit 14 to cause the television device 10 to execute various functions of a television device (such as various functions for viewing television and communication functions). The control unit 14 performs various control processes based on content of a user operation or automatically in accordance with the description of the basic program P1. In particular, the basic program P1 defines that the control unit 14 performs control, if some kind of operation is performed on the operation unit 16 or the remote control 19 by the user, so that information indicating that there has been a user operation is output via the first connection unit 17a or the like. Contents of such an output vary depending on, for example, the manufacturer, the model number, the model type, or the settings of the television device 10.

For example, in the case where the television device 10 is capable of transmitting a control signal called HDMI-CEC and a setting therefor is enabled, the first connection unit 17a compliant with HDMI outputs an HDMI-CEC message indicating device identification information for identifying the television device 10 (e.g., Device Vender ID indicating the manufacturer, the model number (model type), and so on), upon some kind of device being connected to the first connection unit 17a.

In addition, in response to the user performing a power-on operation on the television device, an HDMI-CEC message indicating that a power-on operation has been performed (message for information Give Physical Address?) is output. Further, in response to the user performing source switching operation (corresponding to an input switching operation) after displaying the source switching menu screen 31 illustrated in FIG. 5 described above, an HDMI-CEC message indicating that a source switching operation has been performed is output. Furthermore, in response to the television device 10 entering the power-off state (standby state) in response to a power-off operation, the first connection unit 17a outputs a Standby message indicating that the television device 10 is in the power-off state.

Further, in response to the first connection unit 17a receiving an HDMI-standard-based massage inquiring about the state of the television device 10 (Get Device Power Status message), the television device 10 outputs a message indicating the power state of the television device 10 at that time (HDMI-CED message indicating the power-on state or the power-off state).

Note that various messages described above are not output in the case where the television device 10 does not support HDMI-CEC or in the case where the television device 10 supports HDMI-CEC but the HDMI-CEC setting is disabled. Accordingly, when the HDMI-CEC setting is changed from the enabled state to the disabled state, even the television device 10 that supports HDMI-CEC no longer outputs various messages after the setting is disabled. In addition, depending on the model type of the television device 10, a setting can be made not to output messages even when the HDMI-CEC setting is enabled.

Further, depending on the model type of the television device 10, there are model types whose first connection unit 17a outputs information in response to a user power-on operation or information in response to a user power-off operation other than the messages described above.

For example, with regard to the television device 10 of a certain model type, content of HPD information (Hot Plug Detect information) included in information output from the first connection unit 17 changes from “0” to “−1” in response to a user power-on operation. In the case where output content changes in this manner, HPD information whose content has changed to “−1” corresponds to output information following a user power-on operation. In addition, there are model types for which content of HPD information changes from “−1” to “0” in response to a user power-off operation. In the case where such a change occurs, HPD information whose content has changed to “0” corresponds to output information following a user power-off operation.

Further, there is also the television device 10 that exchanges encryption-related information based on HDCP (High-bandwidth Digital Content Protection system), which is one of copyright protection techniques, with a device connected to the first connection unit 17a. In the exchange of this encryption-related information, in response to a user performing a power-on operation on the television device 10, the television device 10 first transmits, to the device connected to the first connection unit 17a, output information for making an inquiry to start HDCP encryption (corresponding to output information following a power-on operation and indicating establishment of a connection to an external display device). Upon receipt of this output information, the device connected to the first connection unit 17a returns, to the television device 10, information necessary for a response to start HDCP encryption and determines that HDCP encryption can be started (Start enc status). As described above, based on output information for making an inquiry to start HDCP encryption transmitted from the television device 10, the device connected to the first connection unit 17a can detect the power-on state of the television device 10. In addition, in response to the user performing a power-off operation on the television device 10, the output information related to HDCP encryption (corresponding to output information indicating establishment of a connection to an external display device) transmitted from the television device 10 stops (the case of Key NG where a mismatch occurs in the encryption key used in HDCP encryption). The device connected to the first connection unit 17a can detect the power-off state of the television device 10 based on a situation where the output information related to HDCP encryption is no longer obtainable.

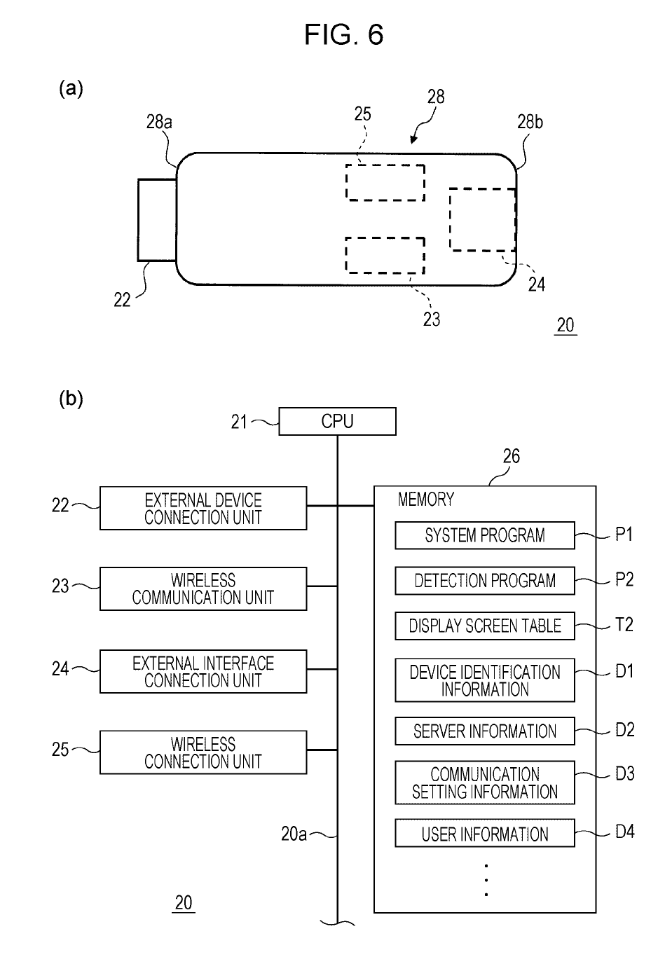

On the other hand, part (a) of FIG. 6 illustrates an external appearance of the communication terminal device 20 connectable to a connection terminal of the first connection unit 17a (HDMI) of the television device 10 described above. The communication terminal device 20 used in the embodiment is typically of a type called a smart stick (smart box), a stick computer, or a smart computer. The communication terminal device 20 does not include a display (display unit) and is used by being connected to an external display device (the television device 10 in the embodiment).

The communication terminal device 20 includes a stick-like casing 26. On one end 28a in the longitudinal direction of the casing 28, a protruding connection terminal of an external device connection unit 22 (corresponding to a connection means) compliant with the HDMI standard is disposed. On another end 28b, a female terminal of an external interface connection unit 24 compliant with the USB standard is disposed. Further, the communication terminal device 20 has a wireless communication unit 23 (corresponding to a communication means) compliant with wireless LAN and a wireless connection unit 25 arranged inside the casing 28.

Part (b) of FIG. 6 illustrates major internal components of the communication terminal device 20. The communication terminal device 20 has a computer-like internal configuration. The communication terminal device 20 can perform desired processes as a result of various application programs being installed therein. In the embodiment, the communication terminal device 20 is capable of notifying the server device 2 of information necessary for the watch-over service provided by the server device 2, as a result of a detection program P2 for detecting the state, such as the power-on state or the power-off state, of a display device (the television device 10 in the embodiment) serving as a connection destination being installed therein.

The communication terminal device 20 includes, for example, a CPU 21, the external device connection unit 22, the wireless communication unit 23, the external interface connection unit 24, the wireless connection unit 25, and a memory 26 (a storage means), which are connected to one another via an internal connection line 20a. The CPU 21 performs various processes for controlling the entire device and performs various processes in accordance with the description of various programs installed in the memory 26. The external device connection unit 22 corresponds to a connection means and is a connection terminal compliant with the HDMI standard, which enables direct connection to the first connection unit 17a of the television device 10 as described above. The wireless communication unit 23 (corresponding to a communication means) is an interface that performs wireless communication. The communication unit 13 according to the embodiment performs wireless LAN communication based on a standard of the IEEE 802.11 family (such as IEEE 802.11b/g, a). In the embodiment, the wireless router 29 is installed in the house H1 as illustrated in FIGS. 1 and 2. The wireless communication unit 23 can be connected to the network NW via this wireless router 29.

The external interface connection unit 24 corresponds to a connection means. A user interface such as a mouse or a keyboard, or an external storage medium can be connected to the external interface connection unit 24. In the embodiment, the external interface connection unit 24 compliant with the USB (Universal Serial Bus) standard is employed. The wireless connection unit 25 also corresponds to the connection means and is a connection unit that performs wireless communication. In the embodiment, the wireless connection unit 25 compliant with the Bluetooth (registered trademark) standard is employed.

The memory 26 stores various programs, information, and others. In the embodiment, the memory 26 stores a system program P1, the detection program P2, a display screen table T2, device identification information D1, server information D2, communication setting information D3, and user information D4, for example. The system program P1 is a basic program corresponding to the OS (operation system). The detection program P2 is an application program that defines various processes related to detection of the state of a display device to which the external device connection unit 22 is connected. The contents defined by this detection program P2 allow the CPU 21 to function as various means, and the details of the contents of the program will be described later.

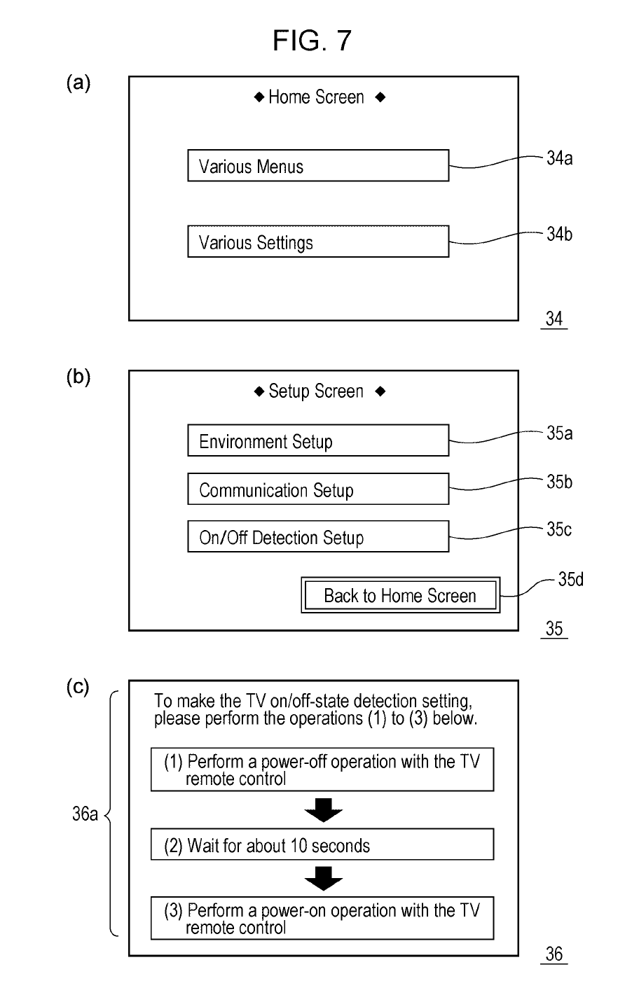

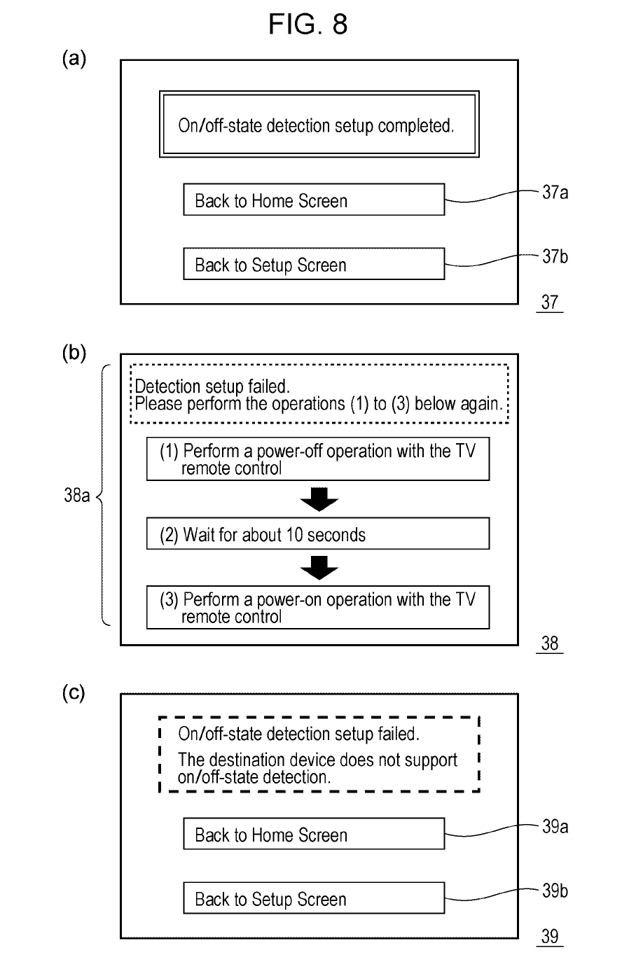

The display screen table T2 stored in the memory 26 stores screen information corresponding to screen content displayed on an external display device (e.g., the television device 10). The screen information is output from the external device connection unit 22 of the communication terminal device 20 to the television device 10. Specific examples of the screen content include a home screen 34 illustrated in part (a) of FIG. 7, a setup screen illustrated in part (b) of FIG. 7, a user instruction screen 36 illustrated in part (c) of FIG. 7, an on/off setup completion screen 37 illustrated in part (a) of FIG. 8, an on/off setup failure screen 38 illustrated in part (b) of FIG. 8, and an on/off setup impossible screen 39 illustrated in part (c) of FIG. 8.

Part (a) of FIG. 7 illustrates the case where screen information corresponding to the home screen 34, among pieces of screen information stored in the display screen table T2, is displayed on the display screen 10a of the television device 10. This home screen 34 includes a first selection item 34a used to select various functions that can be provided by the communication terminal device 20 and a second selection item 34b used to set various settings. Such a home screen 34 is displayed in the following manner. Upon connection of the communication terminal device 20 to the television device 10, screen information corresponding to the home screen 34 is read from the memory 26 and output to the television device 10 via the external device connection unit 22 under control of the CPU 21. In the television device 10, in response to selection of input 1 (HDMI) in source switching (see FIG. 5), the home screen 34 is displayed on the display screen 10a (other screens are also displayed as a result of screen information corresponding to each screen being read from the memory 26). The home screen 34 is also displayed in response to the user performing an operation to back to the home screen from another screen.

Part (b) of FIG. 7 illustrates the case where the setup screen 35 is displayed on the display screen 10a. This setup screen 35 is displayed as a result of screen information corresponding to the setup screen 35 being read from the display screen table T2 in the memory 26 in response to the user selecting the second selection item 34b on the home screen 34 described above. The setup screen 35 includes a first selection item 35a used to perform general environment setup of the communication terminal device 20, a second selection item 35b used to perform various communication-related setup, and a third selection item 35c used to identify a detection setting regarding detection of the power-on/off state of the television device 10 based on the process of the detection program P2. The setup screen 35 further includes a fourth selection item 35d used to accept a user operation to back to the home screen described above. Like the selection items 34a and 34b on the home screen 34 described above, these selection items 35a to 35d are selectable by the user, and the screen contents appropriately change depending on the selected item.

Part (c) of FIG. 7 illustrates the case where the user instruction screen 36 is displayed on the display screen 10a. This user instruction screen 36 is displayed as a result of screen information (user instruction screen information) corresponding to the user instruction screen 36 being read from the display screen table T2 in the memory 26 in response to the user selecting the third selection item 35c on the setup screen 35 described above. The user instruction screen 36 includes screen content 36a indicating an instruction to the user that prompts the user to perform a power-off operation on the television device and then perform a power-on operation after a certain amount of time (after 10 seconds in the embodiment). Although a value of 10 seconds is used as the certain amount of time on the user instruction screen 36 illustrated in part (c) of FIG. 7, the certain amount of time is not limited to 10 seconds, and its value is not limited to any particular value as long as the amount of time enables clear distinction of individual operations when the user performs a power-off operation and then performs a power-on operation. A value of 5 seconds or larger can be generally used.

Part (a) of FIG. 8 illustrates the case where the on/off setup completion screen 37 is displayed on the display screen 10a. This on/off setup completion screen 37 is displayed as a result of screen information corresponding to the on/off setup completion screen 37 being automatically read from the display screen table T2 in the memory 26 upon the detection setup being completed by identifying the detection setting for the power-on/off operation of the television device 10 after the display of the user instruction screen 36 described above. The on/off setup completion screen 37 includes a first selection item 37a used to back to the home screen 34 illustrated in part (a) of FIG. 7 and a second selection item 37b used to back to the setup screen 35 illustrated in part (b) of FIG. 7.

Part (b) of FIG. 8 illustrates the case where the on/off setup failure screen 38 is displayed on the display screen 10a. This on/off setup failure screen 38 is displayed as a result of screen information corresponding to the on/off setup failure screen 37 being automatically read from the display screen table T2 in the memory 26 in the case where the detection setting does not complete even if power-on/off operations are performed on the television device 10 after the display of the user instruction screen 36. The on/off setup failure screen 38 includes screen content 38a for an instruction to the user that prompts the user to again perform a power-off operation and then perform a power-off operation after the certain amount of time.

Part (c) of FIG. 8 illustrates the case where the on/off setup impossible screen 39 is displayed on the display screen 10a. This on/off setup impossible screen 39 is displayed as a result of screen information corresponding to the on/off setup impossible screen 39 being automatically read from the display screen table T2 in the memory 26 in the case where identification of the power-on/off state detection setting ultimately fails even if power-on/off operations are performed on the television device 10 in response to the display of the user instruction screen 36 described above. The on/off setup impossible screen 39 also includes a first selection item 39a used to back to the home screen 34 illustrated in part (a) of FIG. 7 and a second selection item 39b used to back to the setup screen 35 illustrated in part (b) of FIG. 7.

In addition, the device identification information D1 stored in the memory 26 is information indicating the identification code of the communication terminal device 20. The device identification information D1 is information used to distinguish the communication terminal device 20 from the other communication devices or the like when communication is performed. The server information D2 stored in the memory includes information (such as a network address of the server device 2) necessary for the communication terminal device 20 to communicate with the server device 2. The communication setting information D3 includes information (such as the ID of the Internet service provider used by the communication terminal device 20 and an address used to access the server of the Internet service provider) necessary for the communication terminal device 20 to access the Internet via the network NW.

The user information D4 stored in the memory 26 is information concerning the user (the monitored person M1) registered in the watch-over service and includes the name of the user, the nickname of the user, and the identification number (user ID) for identifying the user, for example. The user information D4 including such content is stored in the memory 26 in the following manner. Information (such as the name, the nickname, the address, the age, the gender, the contact address of the watching person, and the password) input by the user in accordance with a certain format at the time of user registration for using the watch-over service is temporarily transmitted to the server device 2. After the user registration has completed, information containing part of the information input by the user is transmitted from the server device 2 to the communication terminal device 20 as the user information D4. The transmitted user information D4 is then stored in the memory 26.

Details of the detection program P2 will be described next. The detection program P2 stored in the memory 26 is an application program that defines processes of the CPU 21 for obtaining the detection result of the power-on state or the power-off state of the television device 10. The detection result serves as a basis for judgement in carrying out the watch-over service provided by the server device 2. The detection program P2 is appropriately installed as an application in the memory 26 of the communication terminal device 20 (obviously, the detection program P2 can be preinstalled in the memory 26 when the communication terminal device 20 is manufactured).

Processing contents defined by the detection program P2 are divided mainly into two parts. One is contents of a detection setting identifying stage of identifying the detection setting for detecting whether the television device, which is a connection destination, is in the power-on state or the power-off state. The other one is contents of a stage of an actual detection process in which the state of device is detected based on an output from the television device 10 in accordance with the identified detection setting and the detection result is transmitted to the server device 2.

As the processing contents of the detection setting identifying stage defined by the detection program P2, the detection program P2 defines that the CPU 21 performs, in response to selection of the third selection item 35c corresponding to the on/off detection setup when the setup screen 35 illustrated in part (b) of FIG. 7 is displayed, a control process to read screen information corresponding to the user instruction screen 36 from the display screen table T2 in the memory 26 and to output the screen information from the external device connection unit 22, in order to display the user instruction screen 36 illustrated in part (c) of FIG. 7 on the television device 10.

After the user instruction screen 36 is displayed on the television device 10, the user first performs a power-off operation. Thus, information following the power-off operation is output from the first connection unit 17a of the television device 10. The user then performs a power-on operation after a certain amount of time (for example, after approximately 10 seconds). Thus, information following the power-on operation is output from the first connection unit 17a of the television device 10. The detection program P2 defines that the CPU 21 performs a control process to obtain such output information from the television device 10 via the external device connection unit 22 appropriately in response to the operation timing and to temporarily store the obtained information in the memory 26.

The detection program P2 defines that the CPU 21 then performs a process of identifying a detection setting used in detection from among a plurality of detection settings for detecting the state of an external display device (the television device 10), on the basis of the output information that has been obtained and stored (the CPU 21 functions as a detection setting identifying means). The plurality of detection settings for detecting the state of the television device 10 include a detection setting based on HPD information in output information of the television device 10 described above and a detection setting based on HDCP information (encryption-related information) of the output information. The detection setting based on HPD information is a setting for detecting the power-on/off state of the television device 10 on the basis of a change in the content of the HPD information. The detection setting based on HDCP information (encryption-related information) is a setting for detecting the power-on/off state of the television device 10 by determining whether HDCP encryption is ready to be started on the basis of whether the HDCP information (encryption-related information) is obtained.

As specific contents of the detection program P2 related to identification of the detection setting, the detection program P2 defines that the CPU 21 performs a process of detecting whether the content of HPD information included in obtained output information has changed from “−1” to “0”. In the case where the CPU 21 successfully detects that the content of HPD information has changed from “−1” to “0” in this process, the CPU 21 determines that the CPU 21 is able to detect that the television device 10 to which the external device connection unit 22 is connected has entered the power-off state in response to a user power-off operation. On the other hand, in the case where the CPU 21 fails to detect that the content of HPD information has changed from “−1” to “0” even if an power-off operation has been performed, the CPU 21 determines that the CPU 21 is unable to detect, from the HPD information, the power-off state of the television device 10 to which the external device connection unit 22 is connected.

The detection program P2 also defines that the power-off state is determined based on HDCP information (encryption-related information). When output information obtained in relation to HDCP encryption is stopped and can no longer be obtained, it can be determined that a mismatch occurs in the encryption key used in HDCP encryption (the case of determining Key NG). The detection program P2 defines that the CPU 21 detects whether output information related to HDCP encryption can no longer be obtained in this way. In the case where the CPU 21 successfully detects that output information related to HDCP encryption can no longer be obtained in this detection process (in the case of Key NG), the CPU 21 determines that the CPU 21 is able to detect that the television device 10 to which the external device connection unit 22 is connected has entered the power-off state in response to a user power-off operation. On the other hand, if the CPU 21 fails to detect a mismatch in the encryption key used in HDCP encryption even if a power-off operation has been performed, the CPU 21 determines that the CPU 21 is unable to detect, from the HDCP information (encryption-related information), the power-off state of the television device 10 to which the external device connection unit 22 is connected.

Further, the detection program P2 defines, with regard to the obtained output information, that the CPU 21 performs a process of detecting whether the content of HPD information included in the output information has changed from “0” to “−1”. In the case where the CPU 21 successfully detects that the content of HPD information has changed from “0” to “−1” in this process, the CPU 21 determines that the CPU 21 is able to detect that the television device 10 to which the external device connection unit 22 is connected has entered the power-on state in response to a user power-on operation. On the other hand, in the case where the CPU 21 fails to detect that the content of HPD information has changed from “0” to “−1” even if a power-on operation has been performed, the CPU 21 determines that the CPU 21 is unable to detect, from the HPD information, the power-on state of the television device 10 to which the external device connection unit 22 is connected.

Furthermore, the detection program P2 defines that the CPU 21 detects, from the HDCP information (encryption-related information), whether HDCP encryption is ready to be started (whether the status has changed to Start enc). In the case where the CPU 21 detects obtainment of output information for making an inquiry to start HDCP encryption (output information indicating establishment of a connection to an external display device), the CPU 21 determines to start an HDCP encryption process and returns a response to be ready to perform a process of starting HDCP encryption (the status of Start enc). In this case, the CPU 21 determines that the CPU 21 is able to detect that the television device 10 to which the external device connection unit 22 is connected has entered the power-on state in response to a user power-on operation. On the other hand, in the case where the CPU 21 fails to detect that HDCP encryption is ready to be started even if a power-on operation has been performed, the CPU 21 determines that the CPU 21 is unable to detect, from the HDCP information (encryption-related information), the power-on state of the television device 10 to which the external device connection unit 22 is connected.

The detection program P2 defines that, in the case where it is determined that the CPU 21 is unable to detect both the power-on state and the power-off state through the processes described above, the CPU 21 performs a control process to set a process count flag in the memory 26 and to read screen information corresponding to the on/off setup failure screen 38 from the display screen table T2 in the memory 26 and output the screen information from the external device connection unit 22 so that the on/off setup failure screen 38 illustrated in part (b) of FIG. 8 is displayed on the television device 10. In addition, in response to display of the on/off setup failure screen 38, information following a power-off operation and information following a power-on operation are output from the first connection unit 17a of the television device 10. Thus, the detection program P2 defines that each of the processes described above is performed again.

The detection program P2 also defines that, in the case where it is determined that the CPU 21 is unable to detect both the power-on state and the power-off state even after the processes are performed again, the CPU 21 performs a control process to read screen information corresponding to the on/off setup impossible screen 39 from the display screen table T2 in the memory 26 and output the screen information from the external device connection unit 22 so that the on/off setup impossible screen 39 illustrated in part (c) of FIG. 8 is displayed on the television device 10. As described above, the detection program P2 defines that, in the case where it is determined that the CPU 21 is unable to detect both the power-on state and the power-off state, the subsequent process related to detection of the device state is not performed because the television device 10 to which the external device connection unit 22 is connected is a model type for which the CPU 21 is unable to detect the power-on state and the power-off state.

On the other hand, in the case where it is determined that the CPU 21 is able to detect both the power-on state and the power-off state through the processes described above, the detection setting is successfully identified and the setup completes. Thus, the detection program P2 defines that the CPU 21 performs a control process to read screen information corresponding to the on/off setup completion screen 37 from the display screen table T2 in the memory 26 and output the screen information from the external device connection unit 22 so that the on/off setup completion screen 37 illustrated in part (a) of FIG. 8 is displayed on the television device 10.

The detection program P2 also defines that the CPU 21 then performs a process of storing the content of the identified detection setting in the memory 26 as detection setting information used in a detection process and performs a process of detecting, upon obtaining output information from the television device 10 via the external device connection unit 22 thereafter, the actual device state based on the obtained output information in accordance with the stored content of the detection setting at that timing and transmitting the detection result to the server device 2 via the wireless communication unit 23. When the detection result is transmitted to the server device 2, the device identification information D1 and the user ID contained in the user information D4 that are stored in the memory 26 are transmitted together to allow the server device 2 to identify the transmission source of the detection result.

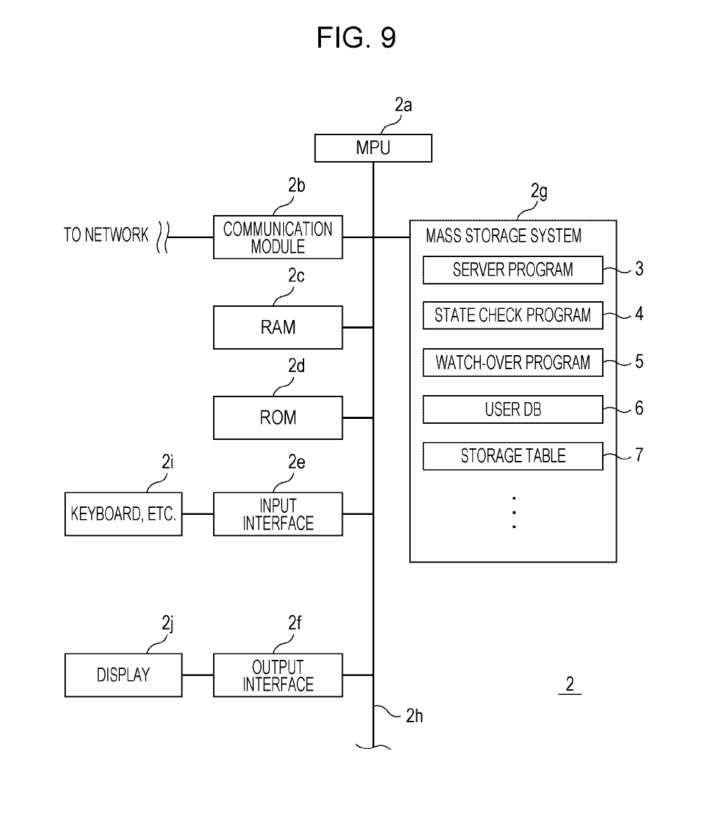

FIG. 9 illustrates major internal components of the server device 2 that provides the watch-over service. The server device 2 is capable of remotely checking the state of an external display device (the television device 10) from a notification concerning the detection result from the communication terminal device 20. A common server computer is employed as the server device 2 according to the embodiment. In the server device 2, various devices or the like are connected, via an internal connection line 2h, to an MPU 2a that performs overall control and various processes. The various devices or the like include a communication module 2b, a RAM 2c, a ROM 2d, an input interface 2e, an output interface 2f, and a mass storage system (HDD system) 2g.

The communication module 2b is a communication device corresponding to a module for connection to the network NW and is compliant with a certain communication standard (e.g., a LAN module). The communication module 2b is connected to the network NW via a certain communication device (illustration of which is omitted, corresponding to a router, for example) and enables the server device 2 to communicate with the above-described communication terminal device 20, the mobile communication terminals A1 to A3 respectively used by the watching persons K1 to K3, and other devices.

The RAM 2c temporarily stores contents, files, and so on related to the processes performed by the MPU 2a. The ROM 2d stores a program that defines contents of basic processes performed by the MPU 2a. The input interface 2e is an interface to which, for example, a keyboard 2i and a mouse that accept operation instructions from an operator of the watch-over service are connected. The input interface 2e transfers an operation instruction accepted from the operator to the MPU 2a. The output interface 2f is an interface to which a display 2j (display output device) is connected. The output interface 2f outputs content involving the processes performed by the MPU 2a to the display 2j to allow the operator to check the content of the current process or the like.

The mass storage system 2g (corresponding to a storage device) stores various databases (DBs) including data necessary for providing the watch-over service and programs, for example. Specifically, the mass storage system 2g stores a server program 3, a state check program 4, a watch-over program 5, a user DB 6, and a detection result table 7, for example.

The server program 3 defines various processes corresponding to a server operation system. The MPU 2a performs processes based on the defined content, whereby the server device 2 exerts a basic function as a server computer. The state check program 4 and the watch-over program 5 will be described later. The user DB 6 and the like are described first.

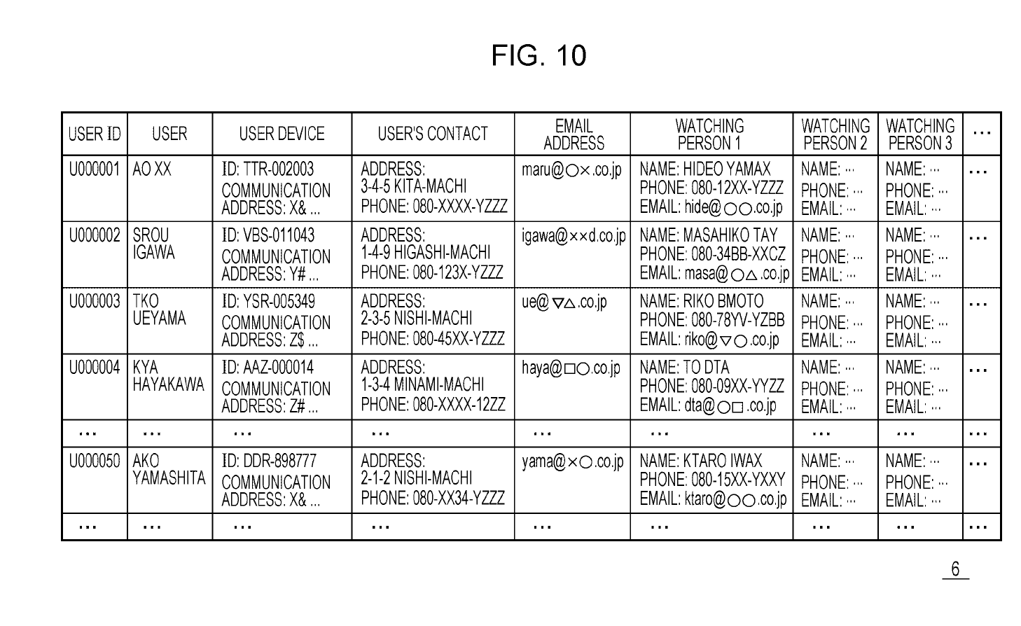

FIG. 10 illustrates an overview of contents of the user DB 6. In the user DB 6, persons who utilize the watch-over service are registered by grouping a monitored person (user) and watching persons who watch over the monitored person. The user DB 6 stores, for each user ID of the monitored person (user) that identifies one group, the name of the monitored person; the device ID (device identification information) and the communication address (a destination set when a signal/information is transmitted from the server device 2 to the communication terminal device 20) of the communication terminal device 20 connected to the television device 10 operated by the monitored person; the address, the phone number, and the email address of the monitored person; and the name, the phone number, and the email address of each watching person (corresponding to the pre-registered contact address) in association with one another.

The server device 2 allows persons who should be notified to receive a certain notification by email, by referring to such a user DB 6. Note that the above-described information of the user DB 5a is provided by the users who receive the watch-over service (the monitored person and the watching persons) during a preparation phase. Such provided information is registered in the user DB 5 in advance. In this way, the users can receive the watch-over service.

The state check program 4 will be described next. The state check program 4 defines that the MPU 2a performs, in response to the communication module 2b receiving the detection result transmitted from the communication terminal device 20, a process of storing, for each user ID and each device identification information D1 that accompany the detection result, the received detection result together with a reception date/time. The storage location is the detection result table 7 that is stored in the mass storage system 2g.

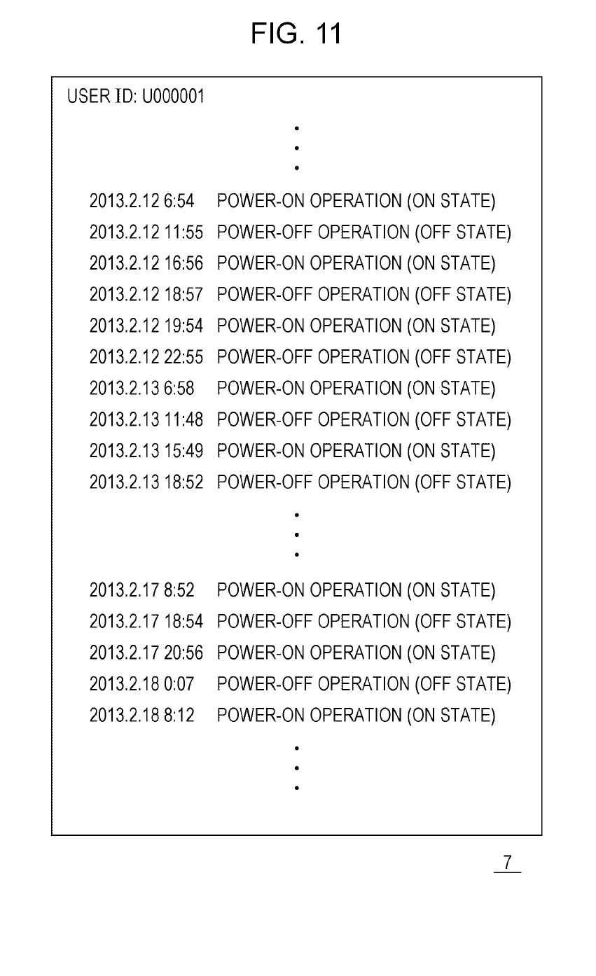

FIG. 11 illustrates part of the detection result table 7. The detection result table 7 has a table structure in which the detection result is stored for a corresponding user ID and corresponding device identification information D1. FIG. 11 illustrates the detection results stored in association with a certain user ID and its corresponding device identification information D1. Each detection result is stored together with the reception date/time.

In addition, the watch-over program 5 defines a process performed by the MPU 2a to determine whether something is wrong with the monitored person M1 who is the user of the television device 10, based on the contents stored in the detection result table 7 described above. The watch-over program 5 according to the embodiment determines that something is wrong with the monitored person M1 in a “state where the television device 10 is not powered on” and a “state where the television device 10 is not powered off for a long time”.

With regard to the “state where the television device 10 is not powered on”, it is determined that something is wrong if the television device 10 does not enter the power-on state even after a certain amount of time (e.g., 24 hours) has passed from when the television device 10 entered the power-off state last time. In addition, with regard to the “state where the television device 10 is not powered off for a long time”, it is determined that something is wrong if the television device 10 does not enter the power-off state even after a certain amount of time (e.g., 15 hours) has passed from when the television device 10 entered the power-on state. Note that the aforementioned conditions used to determine whether something is wrong are merely examples, and other determination conditions may be used obviously. For example, with regard to the “state where the television device 10 is not powered on”, it may be determined that something is wrong if the television device 10 is not powered on even after a certain amount of time (e.g., 3 hours) has passed from the average power-on time. With regard to the “state where the television device 10 is not powered off for a long time”, it may be determined that something is wrong if the television device 10 is kept on even after a certain amount of time (e.g., 3 hours) has passed from the average power-off time.

The watch-over program 5 also defines that, in the case where it is determined that something is wrong as described above, the MPU 2a performs a process of notifying, by email, the watching persons, associated with the user (user ID) for which it is determined that something is wrong, that something is wrong by referring to the user DB 6 illustrated in FIG. 10. In addition, the watch-over program 5 defines that the MPU 2a performs, as practical service contents, a process of notifying the watching persons of an email indicating that “TV is powered on”, upon the television device 10 enters the power-on state for the first time each day.

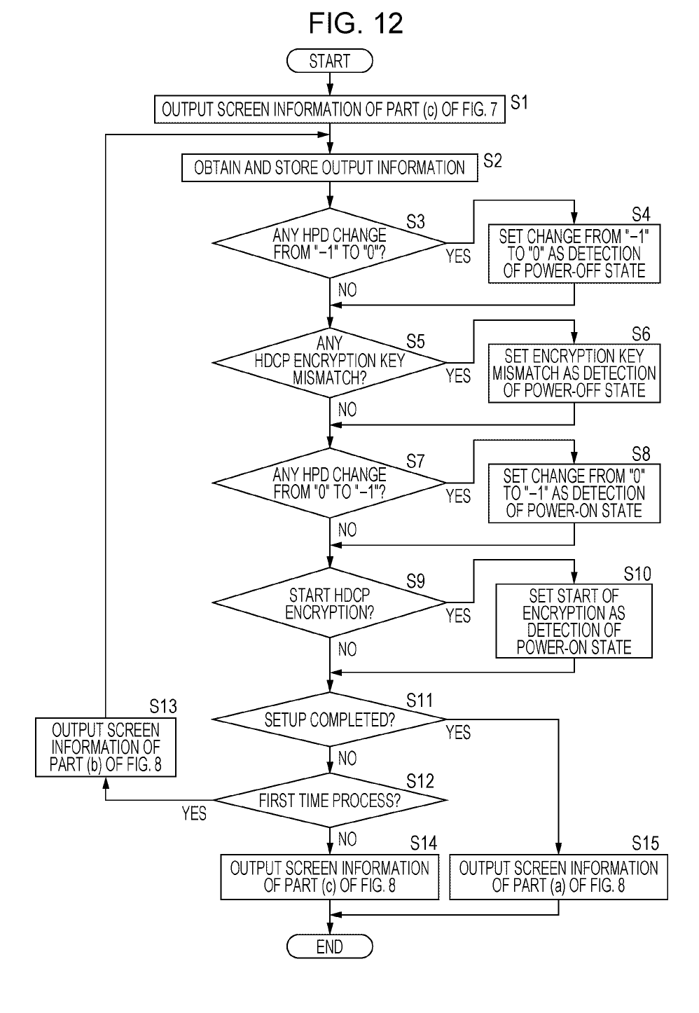

A first flowchart illustrated in FIG. 12 depicts a flow of a series of processing (corresponding to a flow of a process based on contents of a state detection method) in the detection setting identifying stage performed by the communication terminal device 20, which plays a central role in the device state checking system 1 described above. When the external device connection unit 22 of the communication terminal device 20 is connected to the first connection unit 17a (HDMI) of the television device 10 and the source is switched to the first connection unit 17a in the television device 10, the detection program P2 starts running, and the setup screen 35 illustrated in part (b) of FIG. 7 is displayed. It is assumed that this first flowchart starts in response to selection of the third selection item 35c on the displayed setup screen 35.

Referring to the first flowchart, the communication terminal device 20 first outputs screen information corresponding to the user instruction screen 36 illustrated in part (c) of FIG. 7 to the television device 10 (S1). In response to output of this screen information, the user instruction screen 36 illustrated in part (c) of FIG. 7 is displayed on the display screen 10a of the television device 10. The user performs a power-off operation and then a power-on operation in accordance with the instruction to the user indicated on the user instruction screen 36. In response to such operations, information following the power-off operation and information following the power-on operation are sequentially output from the first connection unit 17a of the television device 10. The communication terminal device 20 obtains the output information via the external device connection unit 22 and stores the obtained output information in the memory 26 (S2). The communication terminal device 20 (the CPU 21) then performs the detection setting identifying process.

Specifically, the communication terminal device 20 (the CPU 21) detects whether the stored output information includes HPD information that has changed from “−1” to “0” (S3). In the case of detecting that there is HPD information that has changed from “−1” to “0” (S3: YES), the communication terminal device 20 sets a setting to detect the change of the HPD information from“−1” to “0” as the power-off state and stores such a setting in the memory 26 as one piece of detection setting information (S4). In the case of failing to detect the change of the HPD information from “−1” to “0” (S3: NO), the communication terminal device 20 then determines whether a mismatch occurs in the encryption key used in HDCP encryption by detecting whether HDCP information (encryption-related information) included in the stored output information is no longer stored (output) and is no longer obtainable (S5).

In the case of determining that an encryption key mismatch occurs (S5: YES), the communication terminal device 20 sets a setting to detect the mismatch in the encryption key used in HDCP encryption, the mismatch occurring because HDCP information (encryption-related information) is no longer obtainable, as the power-off state and stores such a setting in the memory 26 as one piece of detection setting information (S6). In the case where there is no encryption key mismatch (S5: NO), the communication terminal device 20 then detects whether the stored output information includes HPD information that has changed from “0” to “−1” (S7).

In the case of detecting that there is HPD information that has changed from “0” to “−1” (S7: YES), the communication terminal device 20 sets a setting to detect the change of the HPD information from “0” to “−1” as the power-on state and stores such a setting in the memory 26 as one piece of detection setting information (S8). In the case of failing to detect the change of the HPD information from “0” to “−1” (S7: NO), the communication terminal device 20 then determines whether HDCP encryption is ready to be started by detecting whether the stored output information includes inquiry information of HDCP information (encryption-related information) for starting HDCP encryption (S9).

In the case of detecting that HDCP encryption is ready to be started (S9: YES), the communication terminal device 20 sets a setting to detect that the state where HDCP encryption is ready to be started as the power-on state and stores such a setting in the memory 26 as one piece of detection setting information (S10). The communication terminal device 20 (the CPU 21) determines whether the detection setting is identified and the setup is completed (S11) after the detection setting information that enables detection of both the power-on state and the power-off state has been stored in the memory 26 through processing of S3 to S10 described above.

In the case of determining that the setup is not completed (S11: NO), the communication terminal device 20 determines whether the detection process of S3 to S10 described above is performed for the first time (S12). In the case of determining that the detection process is performed for the first time (S12: YES), the communication terminal device 20 outputs screen information corresponding to the on/off setup failure screen 38 illustrated in part (b) of FIG. 8 to the television device 10 (S13). As a result of output of this screen information, the on/off setup failure screen 38 illustrated in part (b) of FIG. 8 is displayed on the display screen 10a of the television device 10.

The user again performs a power-off operation and a power-on operation in accordance with the instruction to the user indicated on this on/off setup failure screen 38. In response to such operations, information following the power-off operation and information following the power-on operation are sequentially output from the first connection unit 17a of the television device 10. The communication terminal device 20 obtains the output information via the external device connection unit 22 and stores the obtained output information in the memory 26 (S2). Thereafter, the communication terminal device 20 (the CPU 21) again determines whether the setup is completed (S11) after performing the processing of steps S3 to S10 described above.

In the case of determining that the setup is not completed even after performing the processing of steps S3 to S10 again (S11: NO), it is determined that the detection process is performed for the second time (S12: NO) in the step of determining whether the detection process is performed for the first time (S12). Thus, the communication terminal device 20 outputs screen information corresponding to the on/off setup impossible screen 39 illustrated in part (c) of FIG. 8 to the television device 10 (S14). As a result of output of this screen information, the on/off setup impossible screen 39 is displayed on the display screen 10a of the television device 10. The displayed content allows the user to grasp the fact that the television device 10 is a model type for which the power-on/off states are not detectable. Then, the detection setting process ends. After the on/off setup impossible screen 39 is displayed, the user selects either the first selection item 39a or the second selection item 39b. In response to the selection, the displayed screen is switched to the home screen 34 illustrated in part (a) of FIG. 7 or the setup screen 35 illustrated in part (b) of FIG. 7.

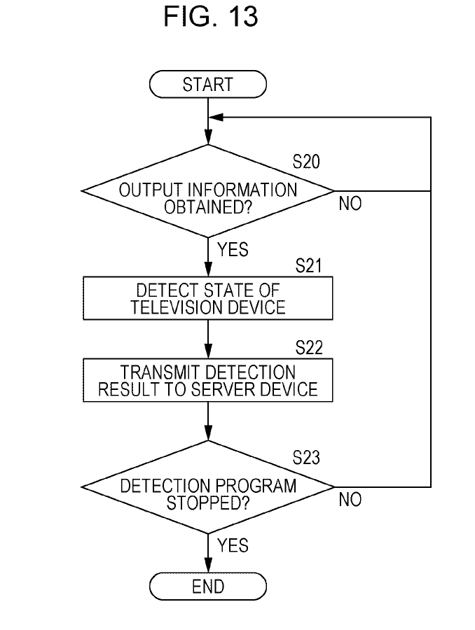

On the other hand, in the case of determining that the setup is completed as a result of the above-described processing (S11: YES), the communication terminal device 20 outputs screen information corresponding to the on/off setup completion screen 37 illustrated in part (a) of FIG. 8 to the television device 10 (S15). As a result of output of this screen information, the on/off setup completion screen 37 is displayed on the display screen 10a of the television device 10. The displayed content allows the user to grasp the fact that detection of the power-on/off states is completed for the television device 10. Then, the detection setting identifying process ends. The process then proceeds to processing in a second flowchart illustrated in FIG. 13. Note that the displayed content is switched to the home screen 34 illustrated in part (a) of FIG. 7 or the setup screen 35 illustrated in part (b) of FIG. 7 in response to the user selecting either the first selection item 37a or the second selection item 37b on the on/off setup completion screen 37.

The second flowchart illustrated in FIG. 13 is started in the case where the detection setup is completed (S11: YES) as a result of the process of the first flowchart illustrated in FIG. 12 described above. The second flowchart illustrates a flow of a process of detecting whether the television device 10 is in the power-on state or the power-off state on the basis of an output from the television device 10. This process is a series of processing performed by the communication terminal device 20 in background, not in relation to the content displayed on the television device 10. The communication terminal device 20 (the CPU 21) determines whether output information is obtained via the external device connection unit 22 from the first connection unit 17a (HDMI) of the television device 10 (S20). In the case where the output information is not obtained (S20: NO), the communication terminal device 20 waits to obtain the output information. In the case where the output information is obtained (S20: YES), the communication terminal device 20 detects the state (the power-on state or the power-off state) of the television device 10 on the basis of the obtained output information in accordance with the detection setting information that is stored in the memory 26 as a result of the process of the first flowchart described above (S21).

The communication terminal device 20 (the CPU 21) then performs a process of transmitting the detection result to the server device 2 together with the device identification information D1 and the user ID (S22). The communication terminal device 20 (the CPU 21) then determines whether the detection program P2 is stopped (S23). In the case where the detection program P2 is not stopped (S23: NO), the process returns to the first step (S20) of determining whether output information is received, and thereafter the above-described processing is repeated until the detection program P2 is stopped. In addition, in the case where the detection program P2 is stopped (S23: YES), the communication terminal device 20 (the CPU 21) ends the detection process.

On the other hand, the server device 2 receives the detection result at any time in response to the communication terminal device 20 performing the process illustrated in the second flowchart of FIG. 13 described above and stores the received detection result in the detection result table 7 illustrated in FIG. 11 together with the reception date/time. In the case of determining, from the detection result table 7, that the television device 10 has entered the power-on state for the first time on that day, the server device 2 transmits an email indicating that “the TV is powered on” to the watching persons associated with the user ID corresponding to the detection result in the determination. Further, the server device 2 checks the contents of the detection result table 7 at any time to detect the “state where the television device 10 is not powered on” and the “state where the television device 10 is not powered off for a long time”. In the case of detecting either state, the server device 2 determines that something is wrong with the monitored person and transmits an email indicating that something is wrong to the watching persons associated with the user ID corresponding to the detection result in the determination.

Transmitting the aforementioned email to the watching persons allows the watching persons to grasp that something is wrong with the monitored person and to immediately take an action, such as visiting the monitored person. As described above, in the first embodiment, the user instruction screen 36 illustrated in part (c) of FIG. 7 and the on/off setup failure screen 38 illustrated in part (b) of FIG. 8 are displayed to cause the user to perform power-on/off operations and perform detection setup. Thus, the setup can be advantageously performed reliably in a short time.

Note that the invention according to the first embodiment is not limited to the contents described above, and various modifications are conceivable. For example, the description has been given of the case where the communication terminal device 20 performs wireless communication via the wireless communication unit 23 to perform network communication; however, the communication terminal device 20 may include a wired communication unit that performs communication via a cable based on Ethernet (registered trademark) and may communicate with the server device 2 over wired communication.

In addition, the device state checking system 1 according to the embodiment is also applicable to services other than the watch-over service. The services other than the watch-over service may be a television broadcast rating state checking service, a maintenance timing checking service, and a network communication service, for example. In the case where the device state checking system 1 is applied to these services, the process performed by the communication terminal device 20 is the same as that described above. With regard to the server device 2, the process is the same up to the step of storing the detection result transmitted from the communication terminal device 20 in the detection result table 7; however, how the detection results stored in the detection result table 7 are processed differs from service to service.

For example, in the case where the device state checking system 1 is applied to the television broadcast rating state checking service, the server device 2 (the MPU 2a) computes a period of the power-on state from the date/time stored together with the detection result in the detection result table 7 illustrated in FIG. 11 and provides the computed power-on period to a business entity that investigates the rating state (such as a server managed by the business entity). The business entity that investigates the rating state ultimately uses the provided power-on period to compute the rating, to conduct a market research (such as a research about in which time slot the TV is powered on, that is, people is watching a television broadcast), and other purposes.

In addition, in the case where the device state checking system 1 is applied to the maintenance timing checking service, the server device 2 (the MPU 2a) computes a period of the power-on state from the date/time stored together with the detection result in the detection result table 7 illustrated in FIG. 11 and provides the computed power-on period to a business entity that checks the device maintenance timing (such as a server managed by a manufacturer of the television device). The business entity that checks the maintenance timing accumulates the provided power-on period for the corresponding device identification information D1 and the corresponding user ID and determines whether the total amount of time of the accumulated power-on periods has exceeded a maintenance interval serving as a reference for maintenance or a life serving as a reference of the life of the device. If the total amount of time exceeds the reference, the business entity contacts the address associated with the user ID to indicate that the maintenance timing has come or the life has reached.

With regard to the case where the device state checking system 1 is applied to the network communication service, because the network communication service is a service based on an application that implements real-time communication via a computer network (mainly the Internet), this service is utilized when devices used by users are in the power-on state. Accordingly, a server that provides this service is notified of “accessible” in the case of the power-on state and “not accessible” in the case of the power-off state. In the case where the present invention is used for purposes, such as the user checking their television use state, instead of applying the device state checking system 1 to the aforementioned various services, the communication terminal device 20 need not transmit the detection result to the server device 2. The configuration is set so that the detection result is accumulated in the communication terminal device 20 and the accumulated detection result is read and output to the television device 10 in response to a user request. In this way, the detection result may be displayed on the television device 10 to allow the user to check the detection result.

### Second Embodiment

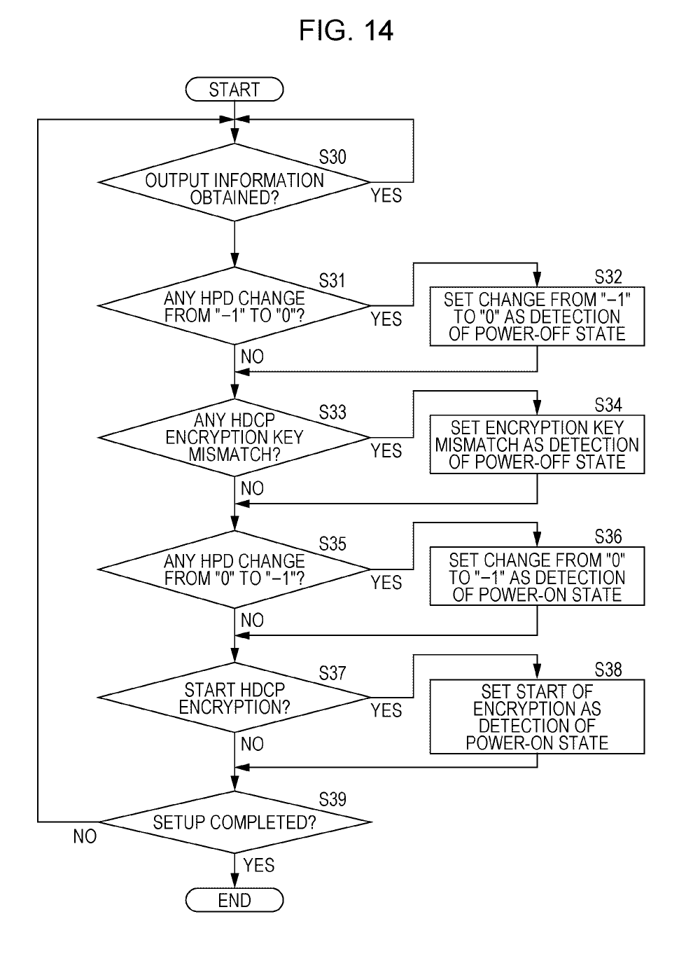

FIG. 14 is a third flowchart used in an invention according to a second embodiment of the present invention. This third flowchart corresponds to the first flowchart in FIG. 12 in the first embodiment described above and is characterized in that setup for detecting the state of the device can be automatically performed in background without performing display of parts (a) to (c) of FIG. 8 described in the first embodiment. The invention according to the second embodiment has configurations such as a basic hardware configuration that are equivalent to those of the first embodiment. Thus, the second embodiment will be described below by using the same reference sings as those used in the first embodiment for the equivalent parts.

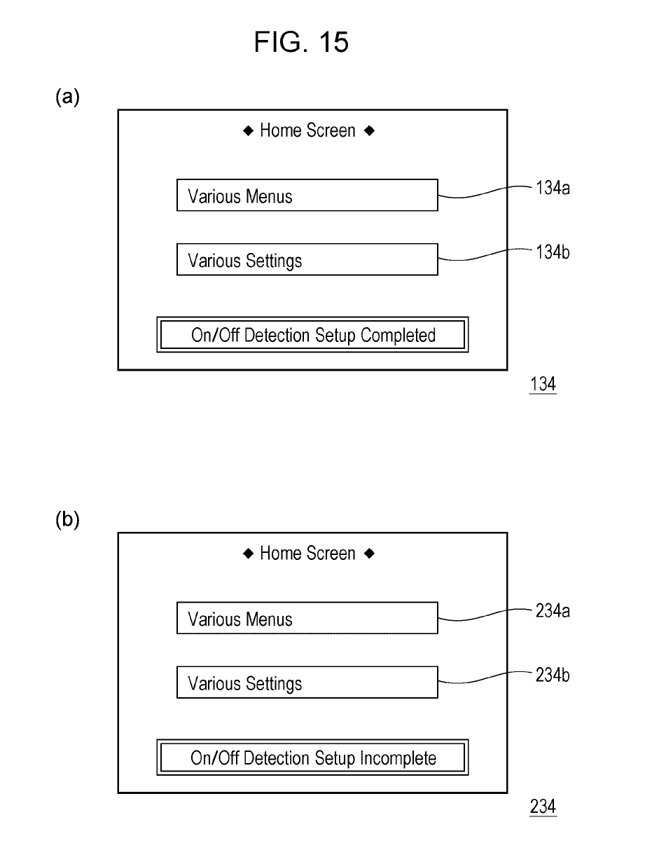

Contents defined by the detection program P2 stored in the memory 26 of the communication terminal device 20 used in the second embodiment include a process of the third flowchart illustrated in FIG. 14. That is, a process defined by the detection program P2 according to the second embodiment for the detection setup stage has contents equivalent to the setup for detecting the power-on state and the power-off state; however, the detection program P2 according to the second embodiment defines that the detection setting identifying process is continued at any time until the detection setting is successfully identified on the basis of output information of the television device 10, without performing a process of displaying the screens illustrated in parts (a) to (c) of FIG. 8. The detection program P2 also performs, in the case where the home screen 34 illustrated in part (a) of FIG. 7 in the first embodiment is displayed on the television device 10, a process to display a home screen 134 illustrated in part (a) of FIG. 15 if the detection setup is completed as a result of a series of processing illustrated in the third flowchart of FIG. 14 and performs a process to display a home screen 234 illustrated in part (b) of FIG. 15 if the detection setup is not completed.

The home screen 134 illustrated in part (a) of FIG. 15 is basically the same as the home screen 34 illustrated in part (a) of FIG. 7 and is characterized in additionally including a display item 134c indicating completion of the power-on/off setup. In addition, the home screen 234 illustrated in part (b) of FIG. 15 is basically the same as the home screen 34 illustrated in part (b) of FIG. 7 and is characterized in additionally including a display item 234c indicating incompletion of power-on/off setup. Accordingly, when the home screen is displayed, the user can check whether the detection setup is completed through either the display item 134c indicating completion of the power-on/off setup illustrated in part (a) of FIG. 15 or the display item 234c indicating incompletion of power-on/off setup illustrated in part (b) of FIG. 15. The communication terminal device 20 according to the second embodiment stores screen information corresponding to the home screen 134 and screen information corresponding to the home screen 234 in the memory 26 so as to be able to appropriately display the home screen 134 illustrated in part (a) of FIG. 15 and the home screen 234 illustrated in part (b) of FIG. 15.

The detection setting identifying process according to the second embodiment will be described next in accordance with the third flowchart in FIG. 14. Note that the process of the third flowchart is performed in parallel with another process. The process of the third flowchart is performed by the communication terminal device 20 in background of another process, without being noticed by the user. The communication terminal device 20 first determines whether output information is obtained from the television device 10 (S30). In this case, if the user performs a power-on operation or a power-off operation on the television device 10, at least one of information following the power-on operation and information following the power-off operation is output.

If the output information is not obtained from the television device 10 (S30: NO), the communication terminal device 20 waits to obtain the output information. If the output information is obtained (S30: YES), the communication terminal device 20 (the CPU 21) performs processing of steps of S31 to S38 having processing contents equivalent to that of steps of S3 to S10 of the first flowchart in FIG. 12 described above. The communication terminal device 20 (the CPU 21) then determines whether the setup is completed (S39) after detection setting information that allows detection of both the power-on state and the power-off state is identified and stored in the memory 26 through the processing of S31 to S38.

In the case of determining that the setup is not completed (S39: NO), the communication terminal device 20 (the CPU 21) returns the process to the first step (S30) and thereafter repeatedly performs processing of steps S30 to S39 until the setup is completed. If the user performs an operation to display the home screen when the setup is incomplete as in this case, the communication terminal device 20 (the CPU 21) performs a process of displaying the home screen 234 illustrated in part (b) of FIG. 15 on the television device 10.

In the case of determining that the setup is completed (S39: YES), the communication terminal device 20 (the CPU 21) ends the detection setting identifying process in this step. Then, as in the first embodiment, the process of the second flowchart illustrated in FIG. 13 is performed. If the user performs an operation to display the home screen after the setup has been completed as in this case, the communication terminal device 20 (the CPU 21) performs a process of displaying the home screen 134 illustrated in part (a) of FIG. 15 on the television device 10.

The invention according to the second embodiment is similar to that according to the first embodiment except for the above-described contents, and various modifications described in the first embodiment are also applicable to the second embodiment. The second embodiment is advantageous in that detection setup can be performed usually by merely using the television device 10 without any user operation for detection setup. The detection setup process of the first embodiment and the detection setup process of the second embodiment described above can be used in combination. In this case, a configuration is conceivable in which when the communication terminal device 20 is connected to the television device 10 for the first time, the detection setup process according to the first embodiment is performed, and when content of output information has changed in response to the user changing the setting of the television device 10, the detection setup process according to the second embodiment is performed, for example.

### Third Embodiment

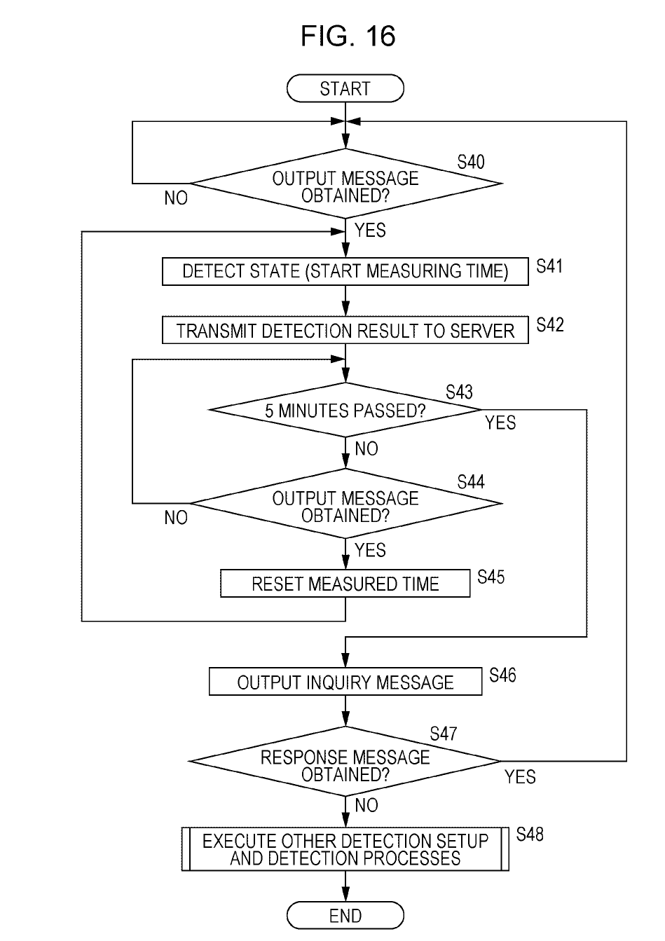

FIG. 16 is a fourth flowchart used in an invention according to a third embodiment of the present invention. This fourth flowchart is characterized in that the state of the television device 10 can be immediately detected without performing steps of S3 to S10 of the first flowchart in FIG. 12 in the first embodiment, which is described above in relation to identification of the detection setting. The invention according to the third embodiment has configurations such as a basic hardware configuration that are equivalent to those of the first embodiment. Thus, the third embodiment will be described below by using the same reference sings as those used in the first embodiment for the equivalent parts.

Contents defined by the detection program P2 stored in the memory 26 of the communication terminal device 20 used in the third embodiment include a process of the fourth flowchart illustrated in FIG. 16. The detection program P2 according to the third embodiment supports the case where a transmission setting of a control signal called HDMI-CEC is enabled in the television device 10 (hereinafter, referred to as “HDMI-CEC is enabled)”. In the case where HDMI-CEC is enabled, the television device 10 outputs a message indicating the power-on state or a message indicating the power-off state from the first connection unit 17a. Thus, the detection program P2 according to the third embodiment includes contents defining that at least one of the output messages is obtained via the external device connection unit 22 and it is detected and determined whether the television device 10 is in the power-on state or the power-off state on the basis of contents of the obtained output message.

In addition, in the case where HDMI-CEC is enabled, the television device 10 outputs, in response to the user performing a source switching operation, a message indicating that the source switching operation has been performed from the first connection unit 17a. Thus, the detection program P2 according to the third embodiment includes contents defining that at least one of the above-described output message indicating the power-on state or the power-off state and the output message indicating that the source switching operation has been performed is obtained, and the state (the power-on/off state, the state where the source switching operation has been performed) of the television device 10 is detected on the basis of the obtained output message. The detection program P2 according to the third embodiment also defines that the CPU 21 performs a process of transmitting the detection result to the server device 2 in the case of detecting the state of the television device 10 on the basis of the obtained output message.

Further, in the case where HDMI-CEC is enabled, HDMI-CEC may be disabled later in the television device 10 in response to a user setup operation. Thus, the detection program P2 according to the third embodiment defines that the CPU 21 performs, in the case of obtaining a message output from the television device 10, a process of outputting, from the external device connection unit 22 to the television device 10, a message (e.g., a Get Device Power Status message) for inquiring about the state of the television device 10 after a certain amount of time (e.g., 5 minutes) from the detection of the state of the device based on the output message.

Furthermore, the detection program P2 according to the third embodiment defines that the CPU 21 determines, in the case of outputting an inquiry message request, whether a response message indicating the power state at that time is obtained from the television device 10.

The detection program P2 according to the third embodiment defines that, in the case where none of the above-described output messages are obtainable, processes such as the detection setting identifying and detection processes are performed in accordance with the processing contents described in the first embodiment.

Content of a series of processing (content of the device state checking method) performed by the communication terminal device 20 according to the third embodiment whose the external device connection unit 22 is connected to the first connection unit 17a of the television device 10 will be described based on the fourth flowchart in FIG. 16. Note that it is assumed that the television device 10 is ready to output an HDMI-CEC message when this fourth flowchart is started.

First, the communication terminal device 20 (the CPU 21) determines whether an output message based on HDMI-CEC is obtained from the television device 10 (S40). In the case of not obtaining the output message (S40: NO), the communication terminal device 20 (the CPU 21) enters a state of waiting for the output. In the case of obtaining the output message (S40: YES), the communication terminal device 20 (the CPU 21) detects the state of the television device 10 on the basis of contents of the obtained message (S41). At that time, the communication terminal device 20 (the CPU 21) also starts a time measuring process.

The communication terminal device 20 (the CPU 21) then performs a process of transmitting the detection result to the server device 2 (S42) and determines whether a certain amount of time (5 minutes) has passed from the start of time measuring (S43). If the certain amount of time has not passed (S43: NO), the communication terminal device 20 (the CPU 21) determines whether a new output message is obtained (S44). In the case of obtaining a new output message (S44: YES), the communication terminal device 20 (the CPU 21) resets the measured time (S45), and the process returns to step (S41) of detecting the state of the device, in which the state of the device is detected based on content of the new output message. In the case of not obtaining any new output message (S44: NO), the process returns to step (S43) of determining whether the certain amount of time has passed. Thereafter, processing of steps S43 and S44 is repeatedly performed until the certain amount of time passes unless a new output message is obtained.

If the certain amount of time has passed (S43: YES), the communication terminal device 20 (the CPU 21) resets the measured time and performs a process of outputting a message for inquiring about the state of the television device 10 (e.g., a Get Device Power Status message) to the television device 10 (S46). The communication terminal device 20 (the CPU 21) then determines whether a response message is obtained in response to this inquiry (S47).

If the response message is obtained (S47: YES), it is indicated that HDMI-CEC is still enabled and the television device 10 is able to output a message. Thus, the process returns to the first step, i.e., S40, and the above-described processing is repeated again.

If the response message is not obtained (S47: NO), HDMI-CEC is disabled in response to a user setting change operation or the like or the setting being changed not to output a message in the television device 10, and an output message from the television device 10 is no longer expected thereafter. Thus, the detection setting identifying process and the detection process (see the first flowchart in FIG. 12 and the second flowchart in FIG. 13) described above in the first embodiment are performed (S48).

As described above, in the invention according to the third embodiment, the state of the device is detected based on an output message from the television device 10. Thus, the invention according to the third embodiment is advantageous particularly in that the state of the device can be immediately grasped reliably without performing the device setting identifying process. The invention according to the third embodiment is similar to that according to the first embodiment except for the above-described contents, and various modifications described in the first embodiment are also applicable to the third embodiment. With regard to the detection setting identifying process, it is described that the processing of the first embodiment is used in step S48 of the fourth flowchart in FIG. 16; however, the detection setting identifying process (see the third flowchart in FIG. 14) described in the second embodiment can be used instead of using the detection setting identifying process according to the first embodiment. Further, as described in the modification of the second embodiment, the processes of the first and second embodiments can be used in combination.

### Fourth Embodiment

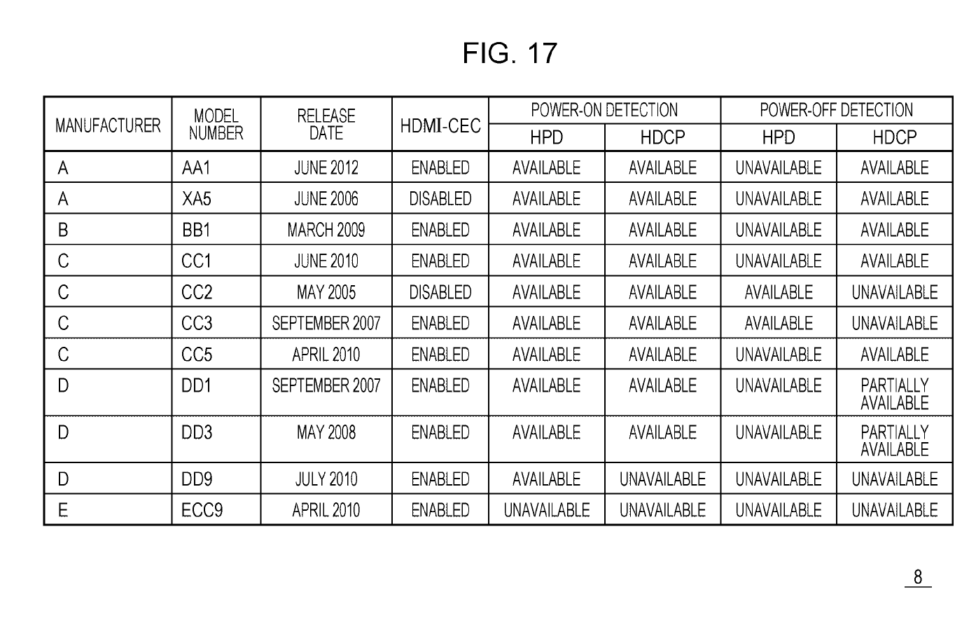

FIG. 17 illustrates an example of a detection setting table 8 used in an invention according to a fourth embodiment of the present invention. In this detection setting table 8, the release date and a plurality of kinds of detection setting information used for detecting the state of the display device on the basis of an output from the display device are associated for each of models (device identification information) indicating the manufacturer and the model number of a plurality of display devices (television devices). The invention according to the fourth embodiment is characterized in that the detection setting can be easily identified reliably on the basis of this detection setting table 8. The invention according to the fourth embodiment has configurations such as a basic hardware configuration that are equivalent to those of the first embodiment. Thus, the fourth embodiment will be described below by using the same reference sings as those used in the first embodiment for the equivalent parts.

The server device 2 (see FIG. 9) used in the fourth embodiment stores the detection setting table 8 in the mass storage system 2g. As illustrated in FIG. 17, the detection setting table 8 stores detection setting information for each of a plurality of display devices (television devices). Kinds of the detection setting information stored in the detection setting table 8 according to the fourth embodiment include information regarding detection as to whether HDMI-CEC is enabled by default, information regarding detection of a change in HPD information to detect the power-on/off state, and information regarding detection of the presence or absence of HDCP information (encryption-related information) to detect the power-on/off state (the detection setting information is information indicating whether HDMI-CEC is enabled by default and indicating whether a change in HPD information or an encryption key based on HDCP information (encryption-related information) contained in output information is usable to detect the power-on/off state). Note that the detection setting table 8 illustrated in FIG. 17 is merely an example, and contents of the table are not limited to those illustrated in FIG. 17. For example, obviously, the table may have contents in which only information indicating whether HDMI-CEC is enabled/disabled is associated with the device identification information.

In addition, the state check program 4 stored in the mass storage system 2g defines a process related to the detection setting table 8 in addition to the processes described above in the first embodiment. Specifically, the state check program 4 defines that the MPU 2a performs, in response to the communication module 2b receiving device identification information (the manufacturer and the model number), a process of identifying detection setting information associated with the device identification information in the detection setting table 8. For example, in response to receipt of device identification information indicating a manufacturer “A” and a model number “AA1”, the MPU 2a identifies detection setting information having contents indicating that HDMI-CEC is “enabled”, HPD information is “available” and HDCP information is “available” to detect the power-on state, HPD information is “unavailable” and HDCP information is “available” to detect the power-off state, in accordance with the description of the state check program 4.

The state check program 4 according to the fourth embodiment also defines that the MPU 2a then performs a process of transmitting the identified detection setting information from the communication module 2b to the transmission source of the device identification information. Note that the detection setting table 8 is updated every time a new display device (television device) is released. Thus, upon receipt of a table update notification from an external server of a distribution source of the detection setting table 8, the server device 2 downloads the updated detection setting table 8 and stores the new one in the mass storage system 2g in place of the old one.

On the other hand, it is defined that the communication terminal device 20 used in the fourth embodiment inquires the server device 2 about device identification information of an external display device serving as its connection destination, thereby downloading and storing detection setting information for the external display device, and performs a process of detecting the state of the device on the basis of the stored detection setting information. Specifically, upon connection of the external device connection unit 22 to a connection terminal of an external display device (e.g., the first connection unit 17a of the television device 10), the external display device outputs an HDMI-CEC message indicating device identification information (e.g., Device Vender ID indicating the manufacturer, the model number (model type), and the like) for identifying the device if the external display device supports HDMI-CEC. Thus, the detection program P2 defines that the CPU 21 performs a process of determining whether an output message including such device identification information is obtained.

The detection program P2 also defines that the CPU 21 transmits, if the device identification information is successfully obtained, the obtained device identification information to the server device 2, downloads detection setting information corresponding to the device identification information, and then performs the device state detection process on the basis of the downloaded detection setting information. The detection program P2 defines that, if the downloaded detection setting information includes a plurality of kinds of information, a setting used to detect the state of the device is identified in a predetermined priority order of “HDMI-CEC” and “HPD or HDCP” (the detection program P2 defines for the downloaded detection setting information that a setting used to detect the state of the device is identified in a priority order of “HDMI-CEC”, “HPD”, and “HDCP”.).

Specifically, if the detection setting information contains information indicating that “HDMI-CEC is enabled”, a detection setting similar to that used in the process described above in the third embodiment is preferentially used because detection can be performed easily and reliably based on contents of the output message. In accordance with this detection setting, the device state detection process is performed on the basis of an output (output message) from the display device. In addition, if the detection setting information contains information indicating that “HDMI-CEC is disabled” and “HPD is available” or “HDCP is available”, an output message of “enabled HDMI-CEC”, which has the first priority, is not available. Thus, the detection program P2 defines that a detection setting based on HPD or HDCP, which has the second priority, is used to perform the device state detection process on the basis of an output (output information) from the display device as in the case of the process described above in the first embodiment. The detection program P2 according to the fourth embodiment also defines that, if the device identification information is not successfully obtained or the detection setting information is not successfully downloaded, the detection setting identifying process and the detection process are performed on the basis of the processing contents described above in the first embodiment.

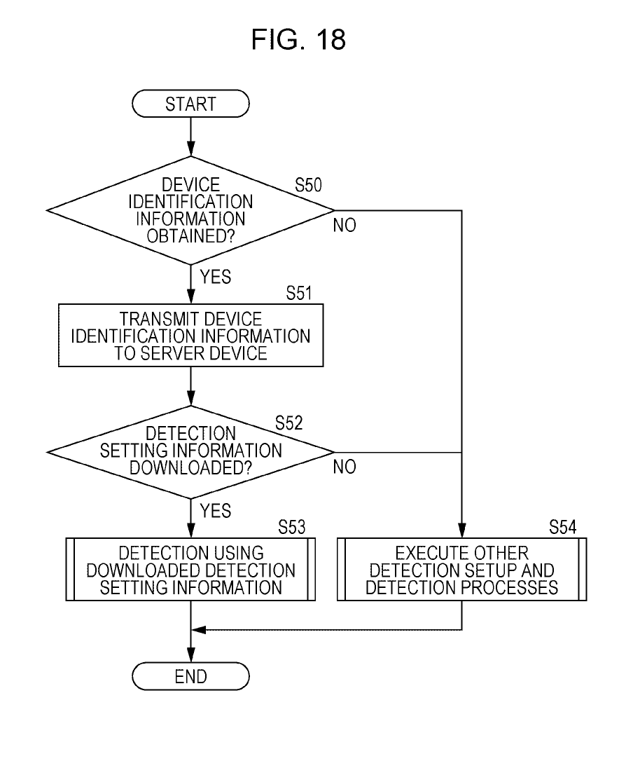

A fifth flowchart illustrated in FIG. 18 depicts a flow of a series of processing (process of the device state checking method) performed by the communication terminal device 20 according to the fourth embodiment. The process performed by the communication terminal device 20 will be described below in accordance with the fifth flowchart. The communication terminal device 20 first determines whether device identification information is obtained from an external display device (the television device 10) (S50). In the case where the device identification information is obtained (S50: YES), the communication terminal device 20 transmits the obtained device identification information to the server device 2 (S51). In response to transmission of the device identification information to the server device 2, the server device 2 identifies detection setting information corresponding to the transmitted device identification information by using the above-described detection setting table 8 and transmits the identified detection setting information. However, the server device 2 may fail to transmit the detection setting information because of some reason (for example, because there is no corresponding detection setting information in the detection setting table 8).

After transmitting the device identification information, the communication terminal device 20 determines whether the detection setting information is successfully downloaded from the server device 2 (S52). If the detection setting information is successfully downloaded (S52: YES), the communication terminal device 20 stores the downloaded detection setting information, performs the device state detection process on the basis of the detection setting information, and transmits the detection result (S53, see the processing contents described in the first to third embodiments). If the downloaded detection setting information contains a plurality of kinds of information, the communication terminal device 20 identifies the order of the detection setting information used in detection in the above-described priority order.

On the other hand, if the device identification information is not successfully obtained (S50: NO) or if the detection setting information is not successfully downloaded (S52: NO), the communication terminal device 20 performs the detection setting identifying process and the detection process described above in the first embodiment (see the first flowchart in FIG. 12 and the second flowchart in FIG. 13) to perform setup for detecting the state of the television device 10, then detect the actual state, and transmit the detection result to the server device 2 (S54).

As described above, the invention according to the fourth embodiment is advantageous in that detection setup can be smoothly done reliably without detecting an output from the television device 10 because detection setting information used in the detection process is identified by using the detection setting table 8 illustrated in FIG. 17. The invention according to the fourth embodiment is similar to that according to the first and other embodiments except for the above-described contents, and various modifications described in the first and other embodiments are also applicable to the fourth embodiment. It is described that the process of the first embodiment is used in step S54 of the fifth flowchart in FIG. 18; however, the process (see the third flowchart in FIG. 14) described in the second embodiment can be used instead of using the process according to the first embodiment. Further, as described in the modification of the second embodiment, the processes of the first and second embodiments can be used in combination.

In addition, in the above description, the communication terminal device 20 downloads the detection setting information from the server device 2 serving as the transmission destination of the detection result; however, in the case where an external server other than the server device 2 stores the detection setting table 8, the communication terminal device 20 may transmit the device identification information to the external server and download the detection setting information from the external server.

Further, in the above description, the detection setting information is downloaded to the communication terminal device 20, and the communication terminal device 20 detects the state of the television device 10; however, a modification is conceivable in which the communication terminal device 20 transmits an output from the television device 10 to the server device 2 without downloading the detection setting information, and the server device 2 detects the state of the television device 10.

In this modification, the communication terminal device 20 performs steps up to S51 in the fifth flowchart in FIG. 18 in the detection setting identifying stage but does not perform the processing of S52 to S54. On the other hand, the server device 2 performs processing up to identification of the detection setting information in the detection setting table 8 on the basis of the device identification information transmitted from the communication terminal device 20. If a plurality of kinds of detection setting information are associated with each device identification information in the detection setting table 8 as illustrated in FIG. 17, the server device 2 performs a process of identifying a setting used to detect the state of the device in a predetermined priority order of “HDMI-CEC” and “HPD or HDCP” as in the above-described case of the communication terminal device 20. Such a process performed by the server device 2 is also defined by the state check program 4.

In addition, in the stage of the detection process, every time the communication terminal device 20 obtains an output other than the device identification information from the television device 10, the communication terminal device 20 just performs a process of transmitting the obtained output to the server device 2 via the network NW. On the other hand, upon receipt of the output (output other than the device identification information) transmitted thereto from the communication terminal device 20, the server device 2 detects the state of the television device 10 on the basis of the received output in accordance with the identified detection setting information and stores the detection result in the storage table 7 in the mass storage system 2g in association with the date/time of the detection process. In such a modification, the detection program P2 of the communication terminal device 20 defines a process for the modification described above. Similarly, the state check program 4 of the server device 2 defines a process for the modification described above.

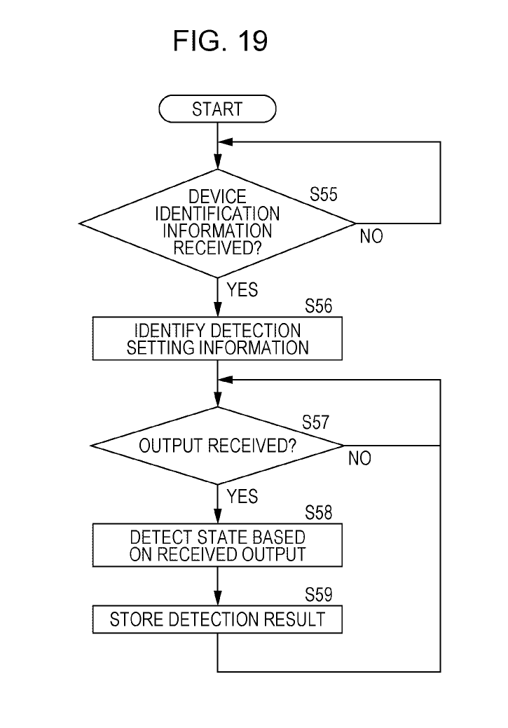

FIG. 19 illustrates a sixth flowchart that depicts a flow of a series of processing (part of the flow of the process of the device state checking method) performed by the server device 20 in the above-described modification of the fourth embodiment. In this sixth flowchart, the server device 20 first determines whether device identification information transmitted thereto from the communication terminal device 20 is received (S55). If the device identification information is not received (S55: NO), the server device 20 enters a state of waiting to receive the device identification information. If the device identification information is received (S55: YES), the server device 20 identifies detection setting information associated with the received device identification information in the detection setting table 8 (S56). The server device 2 then determines whether an output other than the device identification information that is transmitted thereto from the communication terminal device 20 is received (S57). If the output is not received (S57: NO), the server device 2 enters a state of waiting to receive the output. If the output is received (S57: YES), the server device 2 detects the state of the television device 10 on the basis of the received output in accordance with the detection setting information identified in step S56 (S58) and stores the detection result in the storage table 7 together with the detection date/time (S59).

In such a modification of the fourth embodiment, downloading the detection setting information to the communication terminal device 20 is no longer needed. Thus, processing for downloading the detection setting information can be omitted. Also, the communication terminal device 20 need not perform a process for detecting the state of the device, which consequently can reduce the processing load. Further, the server device 2 can perform a process of detecting the state of the device up to storage of the detection result therein, which is advantageous in that a smooth and reliable detection process can be performed.

### Fifth Embodiment

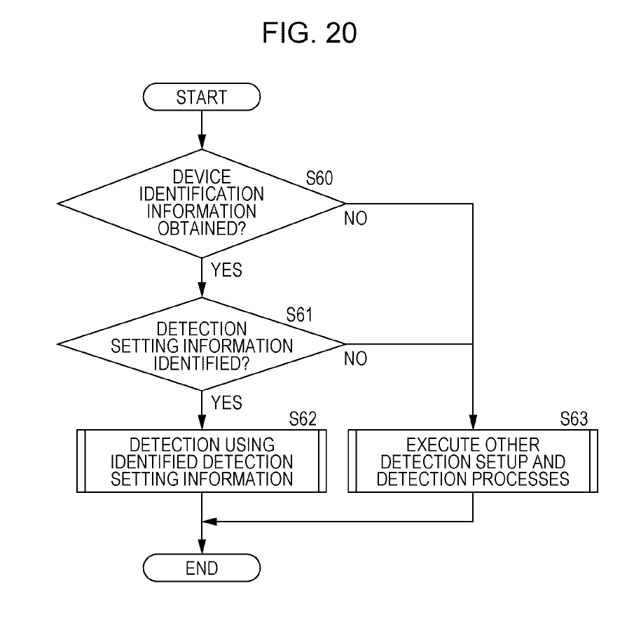

FIG. 20 illustrates a seventh flowchart used in an invention according to a fifth embodiment of the present invention. The invention according to the fifth embodiment uses the detection setting table described above in the fourth embodiment but is characterized in that this detection setting table is stored in the communication terminal device instead of being downloaded and the state of the device is detected. The invention according to the fifth embodiment has configurations such as a basic hardware configuration that are equivalent to those of the first and other embodiments. Thus, the fifth embodiment will be described below by using the same reference sings as those used in the first and other embodiments for the equivalent parts.

The communication terminal device 20 used in the fifth embodiment stores in the memory 26 the detection setting table 8 having the contents illustrated in FIG. 17. This detection setting table 8 may be pre-stored in the memory 26 when the communication terminal device 20 is manufactured or may be downloaded from a distribution server of the detection setting table 8 in response to a user operation after the communication terminal device 20 is manufactured and sold and may be stored in the memory 26. In addition, in response to update of the content of the detection setting table 8 due to release of a new model or the like, the updated detection setting table 8 can be downloaded from the distribution server. When the updated detection setting table 8 is downloaded, the updated detection setting table 8 is stored in the memory 26 in place of the previous detection setting table 8.

The detection program P2 stored in the memory 26 of the communication terminal device 20 defines that the communication terminal device 20 performs the process that is performed by the server device 2 in the fourth embodiment described above. Specifically, the detection program P2 defines that the communication terminal device 20 identifies detection setting information by using the detection setting table 8 stored in the memory 26 and performs a process such as the detection process on the basis of the identified detection setting information. Note that how to identify detection setting information from among a plurality of kinds of detection setting information in the case where the plurality of kinds of detection setting information are associated with device identification information in the detection setting table 8 is similar to that of the fourth embodiment described above (the detection setting used in the detection process is identified from among a plurality of kinds in accordance with a predetermined priority order).

A procedure performed by the communication terminal device 20 according to the fifth embodiment (the process of the device state checking method) will be described in accordance with the seventh flowchart in FIG. 20. The communication terminal device 20 first determines whether device identification information is obtained from an external display device (the television device 10) via the external device connection unit 22 (S60). If the device identification information is obtained (S60: YES), the communication terminal device 20 determines whether detection setting information corresponding to the obtained device identification information is successfully identified in the detection setting table 8 stored in the memory 26 (S61). If the detection setting information is successfully identified (S61: YES), the communication terminal device 20 performs the device state detection process in accordance with the identified detection setting information on the basis of an output obtained from the television device 10 and transmits the detection result (S62, see the processing contents described in the first to third embodiments).

On the other hand, if the device identification information is not successfully obtained (S60: NO) or if the detection setting information is not successfully identified (S61: NO), the communication terminal device 20 performs the detection setting identifying process and the detection process (see the first flowchart in FIG. 12 and the second flowchart in FIG. 13) described above in the first embodiment. Specifically, the communication terminal device 20 identifies a setting for detecting the state of the television device 10, detects the actual state by obtaining an output from the television device, and transmits the detection result to the server device 2 (S63).

As described above, the invention according to the fifth embodiment is advantageous in that the detection process can be performed more easily and smoothly than in the fourth embodiment because the communication terminal device 20 stores the detection setting table 8 and performs the detection process. The invention according to the fifth embodiment is similar to that according to the first and other embodiments except for the above-described contents, and various modifications described in the first and other embodiments are also applicable to the fifth embodiment. It has been described that the process according to the first embodiment is used in step S63 of the seventh flowchart in FIG. 20; however, a modification such as the one described in the fourth embodiment is obviously applicable to the fifth embodiment.

### Sixth Embodiment

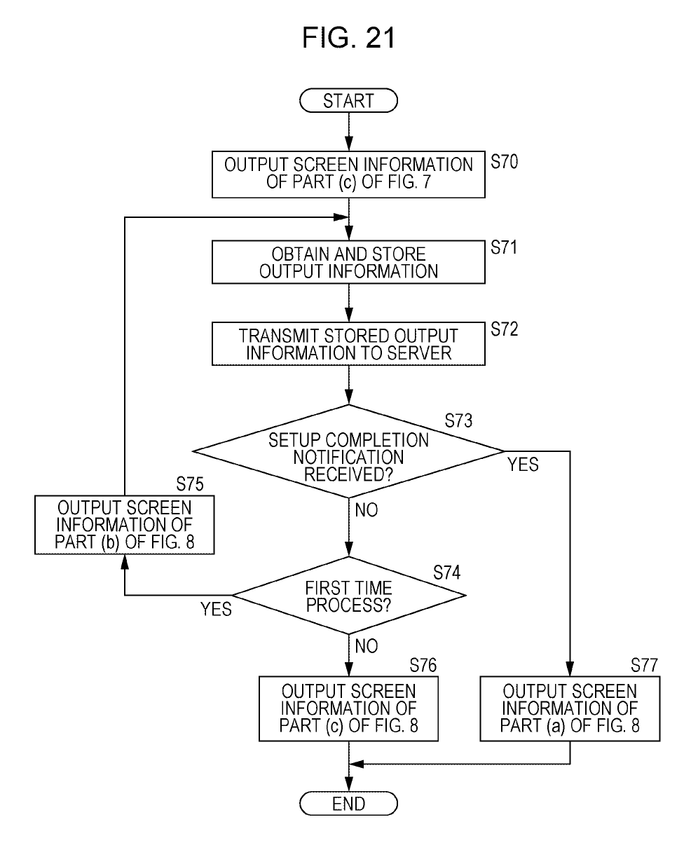

FIGS. 21, 22, and 23 respectively illustrate eighth, ninth, and tenth flowcharts used in an invention according to a sixth embodiment of the present invention. The invention according to the sixth embodiment is related to the above-described invention of the first embodiment. The invention according to the sixth embodiment is characterized in that the detection setting identifying process and the detection process are performed by the server, whereas the detection setting identifying process and the detection process are performed by the communication terminal device in the first embodiment. The invention according to the sixth embodiment has configurations such as a basic hardware configuration that are equivalent to those of the first and other embodiments. Thus, the sixth embodiment will be described below by using the same reference sings as those used in the first and other embodiments for the equivalent parts.

The communication terminal device 20 used in the sixth embodiment does not perform the detection setting identifying process. Thus, the communication terminal device 20 first transmits, to the server device 2, output information obtained from the television device 10. In addition, if the communication terminal device 20 successfully receives a setup completion notification from the server device 2 in response to transmission of the output information, the communication terminal device 20 performs a process of displaying the on/off setup completion screen 37 illustrated in part (a) of FIG. 8. On the other hand, if the communication terminal device 20 receives a setup failure notification instead of receiving a setup completion notification, the communication terminal device 20 performs a process of displaying the on/off setup failure screen 38 illustrated in part (b) of FIG. 8 and then performs the similar process again. If the communication terminal device 20 receives a setup failure notification thereafter, the communication terminal device 20 performs a process of displaying the on/off setup impossible screen 39 illustrated in part (c) of FIG. 8.

In addition, the communication terminal device 20 does not perform the detection process subsequent to the identification of the detection setting. Upon obtaining an output signal from the television device 10, the communication terminal device 20 performs a process of transmitting the output signal to the server device 2 without performing any processing. The communication terminal device 20 according to the sixth embodiment performs processes similar to those of the first embodiment except for the above-described ones.

In addition, the server device 2 used in the sixth embodiment performs the detection setting identifying process that is performed by the communication terminal device 20 in the first embodiment. Upon completing the setup, the server device 2 stores the detection setting information and transmits a setup completion notification to the communication terminal device 20. If the setup fails, the server device 2 transmits a setup failure notification to the communication terminal device 20. Further, if the server device 2 receives output information from the communication terminal device 20 in a detection process subsequent to the detection setup, the server device 2 detects the state of the device in accordance with the stored detection setting information and stores the detection result together with the detection date/time.

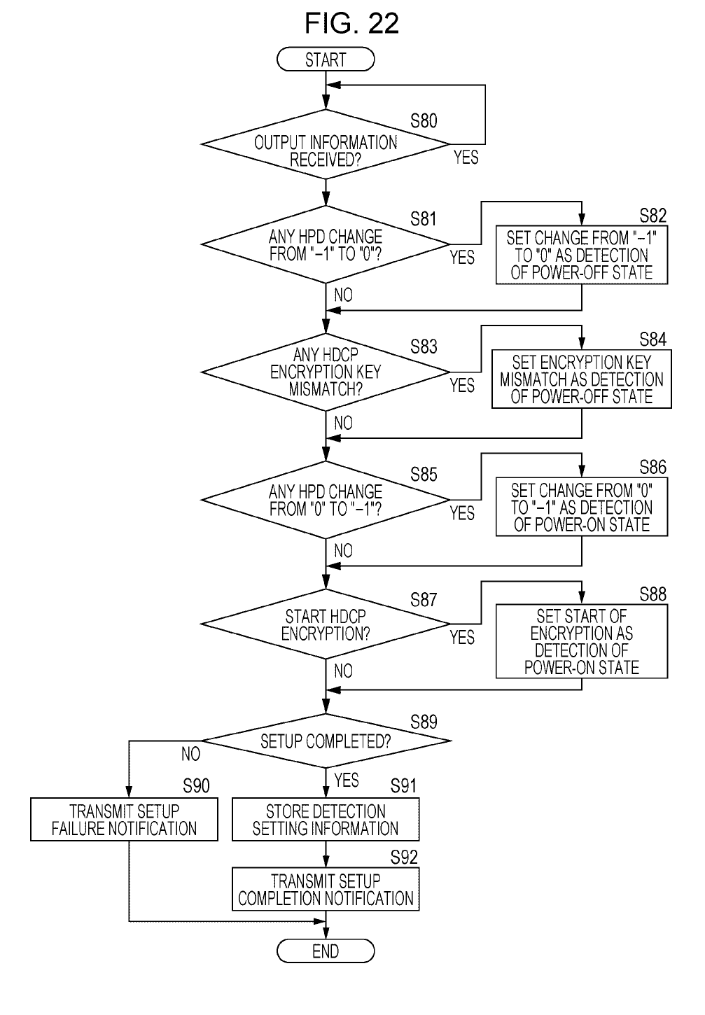

The eighth flowchart illustrated in FIG. 21 depicts a flow of a series of processing performed by the communication terminal device 20 in the detection setting identifying stage. The ninth flowchart illustrated in FIG. 22 indicates a flow of processing performed by the server device 2 also in the detection setting identifying stage. Processing contents of the detection setting identifying stage (contents of the device state checking method) according to the sixth embodiment will be described below by using the eighth and ninth flowcharts.

Referring first to the eighth flowchart in FIG. 21, the communication terminal device 20 outputs, to the television device 10, screen information corresponding to the user instruction screen 36 illustrated in part (c) of FIG. 7 (S70), sequentially obtains information following a power-off operation and information following a power-on operation that are output from the television device 10, and stores the obtained output information in the memory 26 (S71). The communication terminal device 20 then transmits the stored output information to the server device 20 (S72).

On the other hand, referring to the ninth flowchart in FIG. 22, the server device 2 determines whether the output information is received from the communication terminal device 20 (S80). If the output information is not received (S80: NO), the server device 2 enters a state of waiting to receive the output information. If the output information is received (S80: YES), the server device 2 performs, on the received output information, processing of steps S81 to S88 having processing contents equivalent to those of steps S3 to S10 of the first flowchart in FIG. 12 described above. After such processing of S81 to S88, the server device 2 determines whether the setup for detecting the state of the device is completed (S89).

If the server device 2 determines that the setup is not completed (S89: NO), the server device 2 transmits a setup failure notification to the communication terminal device 20 (S90). If the server device 2 determines that the setup is completed (S89: YES), the server device 2 stores the detection setup information in the mass storage system 2g (S91) and transmits a setup completion notification to the communication terminal device 20 (S92).

Referring back to the eighth flowchart in FIG. 21, the communication terminal device 20 determines whether a setup completion notification is received from the server device 2 (S73). If a setup failure notification is received instead of a setup completion notification (S73: NO), the communication terminal device 20 determines whether the processing up to step S73 is performed for the first time (S74). If the communication terminal device 20 determines that the processing up to step S73 is performed for the first time (S74: YES), the communication terminal device 20 outputs, to the television device 10, screen information corresponding to the on/off setup failure screen 38 illustrated in part (b) of FIG. 8 (S75). The process then returns to step S71, and the above-described processing is repeated.

If the communication terminal device 20 receives a setup failure notification again instead of receiving a setup completion notification after the processing is repeated (S73: NO), the processing up to step S73 is performed for the second time (S74: NO). Thus, the communication terminal device 20 outputs, to the television device 10, screen information corresponding to the on/off setup impossible screen 39 illustrated in part (c) of FIG. 8 (S76). On the other hand, if the communication terminal device 20 receives a setup completion notification (S73: YES), the communication terminal device 20 outputs, to the television device 10, screen information corresponding to the on/off setup completion screen 37 illustrated in part (a) of FIG. 8 (S77).

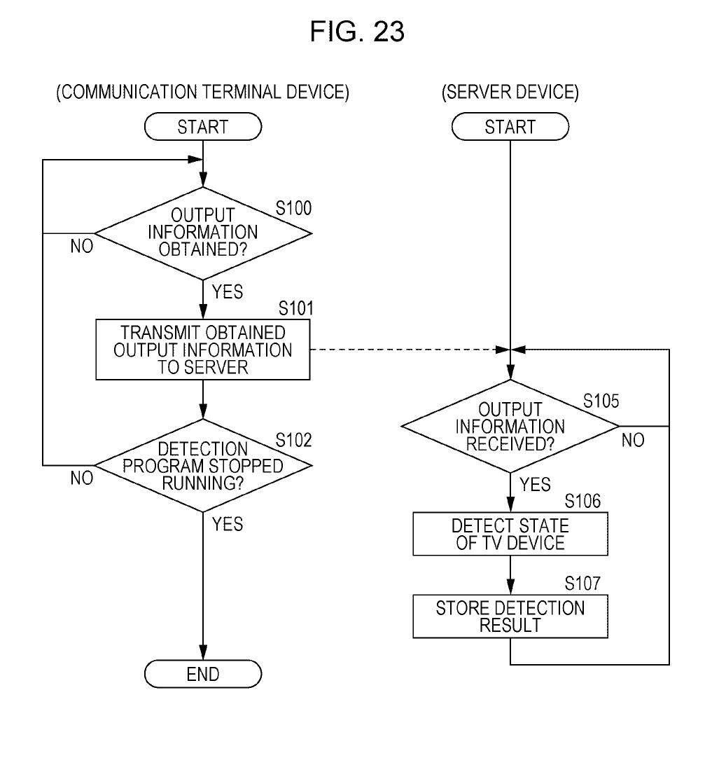

The tenth flowchart in FIG. 23 illustrates a flow of processes performed by the communication terminal device 20 and the server device 2 to detect the state of the device and illustrates the processes that can be performed in the case where the detection setup is completed through the processes of the eighth and ninth flowcharts described above. The communication terminal device 20 first determines whether output information is obtained from the television device 10 (S100). If the output information is not obtained (S100: NO), the communication terminal device 20 waits to obtain the output information. If the output information is obtained (S100: YES), the communication terminal device 20 transmits the obtained output information to the server device 2 (S101). The communication terminal device 20 then determines whether the detection program P2 is stopped (S102). If the detection program P2 is not stopped (S102: NO), the process returns to the first step (S100) of determining whether output information is obtained. Thereafter, the above-described processing is sequentially repeated until the detection program P2 is stopped. If the detection program P2 is stopped (S102: YES), the communication terminal device 20 ends the detection process.

On the other hand, the server device 2 determines whether output information is received from the communication terminal device 20 (S105). If the output information is not received (S105: NO), the server device 2 waits to receive the output information. If the output information is received (S105: YES), the server device 2 detects the state (the power-on state or the power-off state) of the television device 10 on the basis of the received output information in accordance with the stored detection setting information (S106). The server device 2 then stores the detection result in the storage table 7 together with the detection date/time (S107). The process then returns to the first step, i.e., S105, and the above-described processing is repeated.

As described above, the invention according to the sixth embodiment is advantageous in that the processing load of the communication terminal device 20 can be made lower than that of the first embodiment because the server device 2 plays a leading role to perform the detection setting identifying process and the detection process. The invention according to the sixth embodiment is similar to that according to the first and other embodiments except for the above-described contents, and various modifications described in the first and other embodiments are also applicable to the sixth embodiment.

### Seventh Embodiment

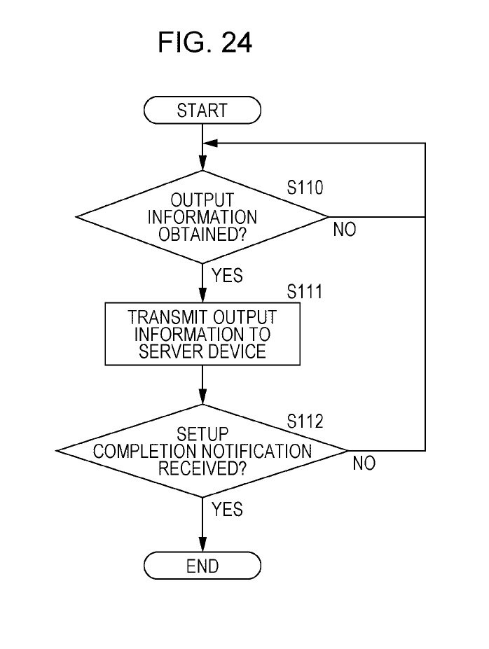

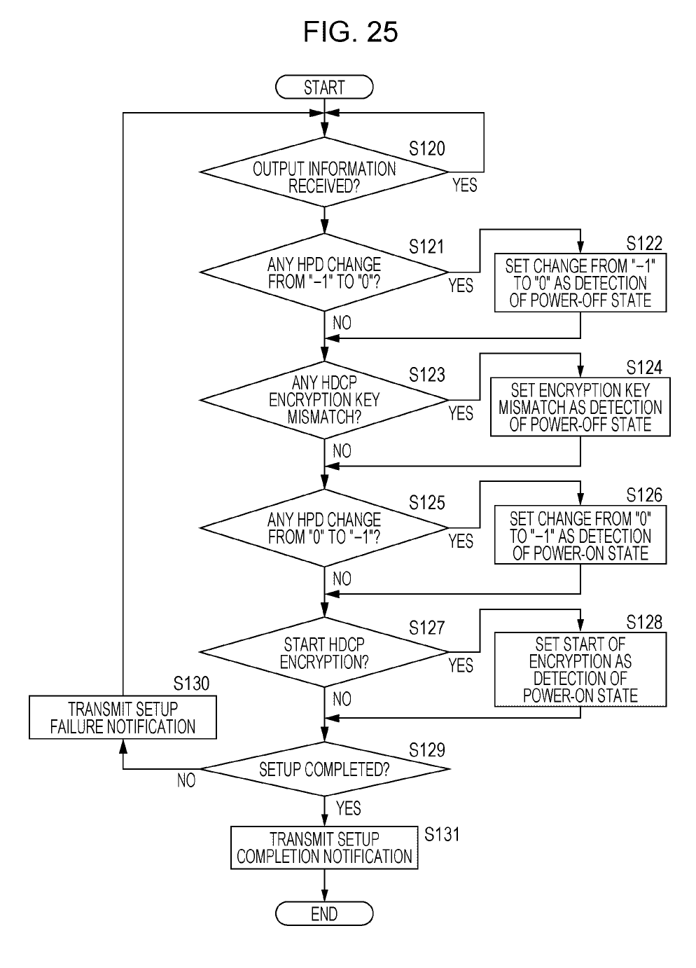

FIGS. 24 and 25 respectively illustrate eleventh and twelfth flowcharts used in an invention according to a seventh embodiment of the present invention. The invention according to the seventh embodiment is related to the above-described invention according to the second embodiment. The invention according to the seventh embodiment is characterized in that the detection setting identifying process and the detection process are performed by the server as in the sixth embodiment, whereas the detection setting identifying process and the detection process are performed by the communication terminal device in the second embodiment. The invention according to the seventh embodiment has configurations such as a basic hardware configuration that are equivalent to those of the first and other embodiments. Thus, the seventh embodiment will be described below by using the same reference sings as those used in the first and other embodiments for the equivalent parts.

The communication terminal device 20 used in the seventh embodiment does not perform the detection setting identifying process. Thus, the communication terminal device 20 first transmits, to the server device 2, output information obtained from the television device 10. If the communication terminal device 20 successfully receives a setup completion notification from the server device 2 in response to transmission of the output information, the stage of the detection setting identifying process ends. Note that the process performed by the communication terminal device 20 in relation to detection of the state of the device after the detection setup is similar to that of the sixth embodiment described above (see the tenth flowchart in FIG. 23).

In addition, the server device 2 used in the seventh embodiment performs the detection setting identifying process that is performed by the communication terminal device 20 in the second embodiment. Upon completion of the setup, the server device 2 stores the setting information and transmits a setup completion notification to the communication terminal device 20. If the setup fails, the server device 2 repeatedly performs the detection setup. Note that the process performed by the server device 2 in relation to detection of the state of the device after the detection setup is similar to that of the sixth embodiment described above (see the tenth flowchart in FIG. 23).

The eleventh flowchart illustrated in FIG. 24 depicts a flow of a series of processing performed by the communication terminal device 20 in the detection setting identifying stage. The twelfth flowchart illustrated in FIG. 25 indicates a flow of processing performed by the server device 2 also in the detection setting identifying stage, Contents of the detection setting identifying stage in the seventh embodiment will be described below by using the eleventh and twelfth flowcharts.

Referring first to the eleventh flowchart in FIG. 24, the communication terminal device 20 determines whether output information (such as information following a power-off operation or information following a power-on operation) is obtained from the television device 10 (S110). If the output information is not obtained (S110: NO), the communication terminal device 20 enters a state of waiting to obtain the output information. If the output information is obtained (S110: YES), the communication terminal device 20 transmits the obtained output information to the server device 20 (S111).

On the other hand, referring to the twelfth flowchart in FIG. 25, the server device 2 determines whether output information is received from the communication terminal device 20 (S120). If the output information is not received (S120: NO), the server device 2 enters a state of waiting to receive the output information. If the output information is received (S120: YES), the server device 2 performs, on the received output information, processing of steps S121 to S128 having processing contents equivalent to steps of S81 to S88 of the ninth flowchart in FIG. 22 described above. After such processing of S121 to S128, the server device 2 determines whether the setup for detecting the state of the device is completed (S129).

If the server device 2 determines that the setup is not completed (S129: NO), the server device 2 transmits a setup failure notification to the communication terminal device 20 (S130). The process then returns to step S120, and the above-described processing is repeated. If the server device 2 determines that the setup is completed (S129: YES), the server device 2 transmits a setup completion notification to the communication terminal device 20 (S131) and ends the process of the detection setting identifying stage.

Referring back to the eleventh flowchart in FIG. 24, the communication terminal device 20 determines whether a setup completion notification is received from the server device 2 (S112). If the communication terminal device 20 receives a setup failure notification instead of receiving a setup completion notification (S112: NO), the process returns to the first step, i.e., S110, and the above-described processing is repeated. If a setup completion notification is received (S112: YES), the communication terminal device 20 ends the process of the detection setup stage.

As described above, the invention according to the seventh embodiment is advantageous in that the processing load of the communication terminal device 20 can be made lower than that of the second embodiment because the server device 2 plays a leading role to perform the detection setting identifying process and the detection process. The invention according to the seventh embodiment is similar to that according to the first and other embodiments except for the above-described contents, and various modifications described in the first and other embodiments are also applicable to the seventh embodiment.

### Eighth Embodiment

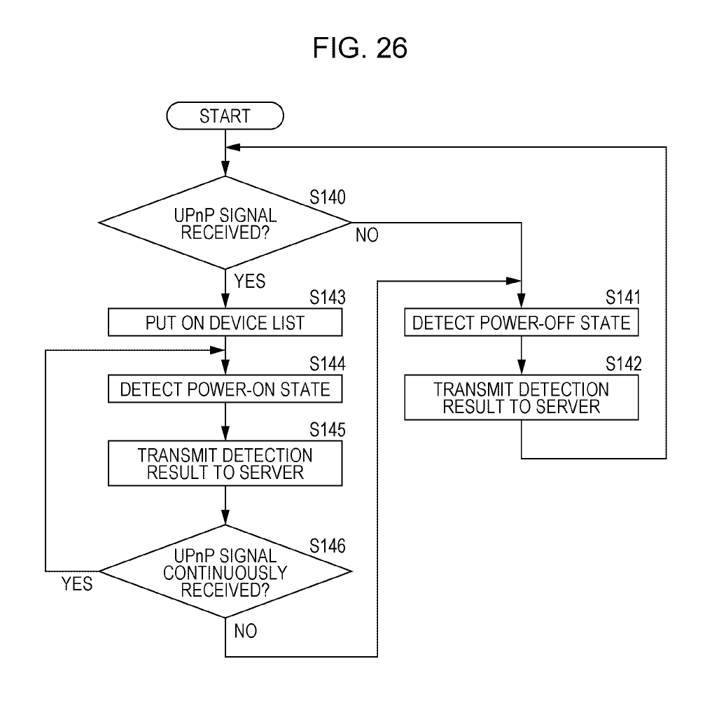

FIG. 26 illustrates a thirteenth flowchart used in an invention according to an eighth embodiment of the present invention. The invention according to the eighth embodiment is characterized in that an output used to identify a detection setting or the like is transmitted over wireless communication (e.g., wireless LAN). The invention according to the eighth embodiment has configurations such as a basic hardware configuration that are equivalent to those of the first and other embodiments. Thus, the eighth embodiment will be described below by using the same reference sings as those used in the first and other embodiments for the equivalent parts.

As in the first to seventh embodiments described above, the communication terminal device 20 outputs screen information (such as video information) corresponding to content displayed on the television device 10 to the first connection unit 17a of the television device 10 from the external device connection unit 22 in the invention according to the eighth embodiment; however, outputs used in the detection setting identifying process and the detection process are received over wireless communication. Accordingly, the communication terminal device 20 wirelessly communicates with the wireless communication unit 17f of the television device 10 by using the wireless communication unit 23 (communication means).

To perform wireless communication, a wireless communication connection needs to be established between the communication terminal device 20 and the wireless communication unit 17f of the television device 10. The communication terminal device 20 detects whether the television device 10 is in the power-on state or the power-off state through a UPnP (Universal Plug and Play) device discovery process for wireless communication. When a wireless communication connection is established, the communication terminal device 20 receives, from the television device 10, a device discovery UPnP signal (corresponding to an output signal indicating establishment of a communication connection to the television device 10) informing a communication destination of device identification information, such as identification information/configurations of the television device 10. Thus, if this UPnP signal is successfully received and obtained, the communication terminal device 20 recognizes the television device 10 as a destination of wireless communication and performs a process of putting the television device 10 on a wireless communication destination device list.

After the connection has been established, the communication terminal device 20 determines whether the connection is maintained based on a UPnP signal transmitted from the television device 10 over wireless communication. If the UPnP signal from the television device 10 stops, the communication terminal device 20 determines that the television device 10 enters the power-off state. As described above, in the eighth embodiment, the CPU 21 serves as a state detecting means to detect whether the television device 10 (external display device) is in the power-on state or the power-off state on the basis of whether a UPnP signal is successfully received and obtained. The CPU 21 performs a process of transmitting the detection result to the server device 2 via the wireless communication unit 23 as in the embodiments described above. Accordingly, the detection program P2 of the communication terminal device 20 according to the eighth embodiment includes contents defining that the CPU 21 performs the above-described contents and the process illustrated in the thirteenth flowchart or the like to function as a signal obtaining means, a state detecting means, and a detection result transmission processing means, for example.

The above-described contents will be described on the basis of the thirteenth flowchart in FIG. 26. In a connection check stage, the communication terminal device 20 determines whether a device discovery UPnP signal is received from the television device 10 over wireless communication (S140). If the UPnP signal is not received (S140: NO), the communication terminal device 20 detects that the television device 10 is in the power-off state (S141) and transmits the detection result to the server device 2 (S142). The process then returns to step S140, and the communication terminal device 20 enters a state of waiting to receive the UPnP signal.

On the other hand, if the UPnP signal is received (S140: YES), the communication terminal device 20 puts the television device 10 on the wireless communication device list (S143), detects that the television device 10 is in the power-on state (S144), and transmits the detection result to the server device 2 (S145). Thereafter, the communication terminal device 20 determines whether the UPnP signal is consecutively received from the television device 10 (S146). If the UPnP signal is consecutively received (S146: YES), the process returns to step S144. On the other hand, if the UPnP signal is no longer received (S146: NO), the communication terminal device 20 detects that the television device 10 enters the power-off state (S141). The invention according to the eighth embodiment is similar to that of the first and other embodiments except for the above-described contents, application to each service described in the first embodiment is also similarly applicable to the eighth embodiment. The invention according to the eighth embodiment configured in this way can be suitably applicable to the case where the state of the device is not detectable with the contents described above in the first to seventh embodiments (contents regarding detection via HDMI connection).

In the case where the television device 10 supports DLNA (Digital Living Network Alliance), there are cases where the television device 10 does not enter the power-off state because the television device 10 stands by for connection. In such cases, the communication terminal device 20 may output the user instruction screen 36 illustrated in part (c) of FIG. 7 to the television device 10, and the television device 10 may display the user instruction screen 36 as in the first embodiment described above, thereby prompting the user to perform a power-off operation and a power-on operation. The communication terminal device 20 may determine in advance whether the state of the device is detectable by checking whether a UPnP signal for each of these operations is receivable.

In addition, as a channel used by the communication terminal device 20 to output screen information to be displayed on the television device 10, channels compliant with standards such as composite, component, MHL (Mobile High-definition Link), IEEE 1394, VGA (Video Graphics Array), and DVI (Digital Visual Interface) are also usable as well as a channel compliant with HDMI. In such cases, connection units compliant with each of the standards are provided in the communication terminal device 20 and the television device 10.

Further, in the case where the communication terminal device 20 is capable of transmitting screen information to be displayed on the television device 10 over wireless communication, connection through the above-described channel may be omitted. In addition, wired communication (e.g., Ethernet (registered trademark) such as wired LAN) can be obviously used instead of wireless communication. In this case, communication interfaces for wired communication are provided in the communication terminal device 20 and the television device 10.

Furthermore, as in the fourth and fifth embodiments described above, the items of the detection setting table 8, which stores, for each model type, detection setting information indicating whether the power-on/off state of the television device 10 is detectable, may further include an item indicating whether power-on/off is detectable based on a UPnP signal over wired/wireless LAN communication. A configuration may be made to determine whether the state of the device is detectable based on a UPnP signal by using the detection setting table according to such a modification. In this case, in accordance with the fourth embodiment described above or other embodiments, for example, a setting used to detect the state of the device is identified in a priority order of “HDMI-CEC”, “HPD”, “HDCP”, and “UPnP”. With such a configuration, if “UPnP is available” in the case where the state is not detectable with any of “HDMI-CEC”, “HPD”, and “HDCP”, it is easily determined that the detection can be performed by using an UPnP signal.

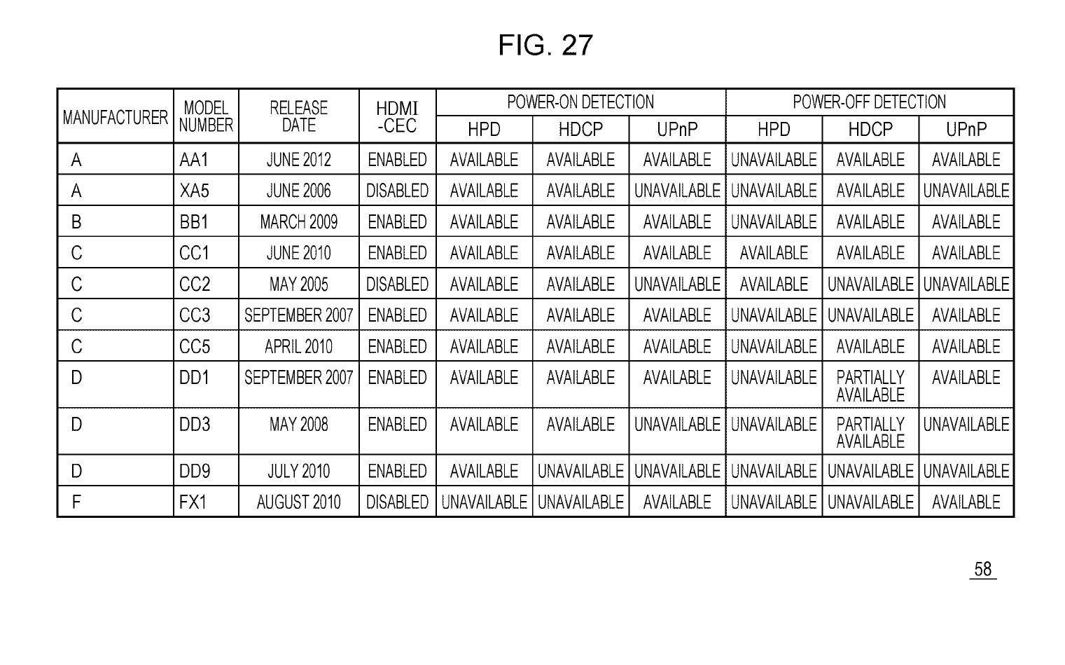

FIG. 27 illustrates an example of a detection setting table 58 according to such a modification of the eighth embodiment. The detection setting table 58 according to this modification additionally includes an item “UPnP” for wireless communication (wireless LAN)/wired communication (wired LAN) at the power-on detection and the power-off detection of the detection setting table 8 illustrated in FIG. 17. Accordingly, the detection setting table 58 according to the modification includes detection setting information for a plurality of kinds of connections or communication schemes such as the HDMI channel and communication (wireless/wired) (includes four kinds of detection setting information in total).

With regard to how to identify certain detection setting information in such a detection setting table 58, the identification is performed in accordance with the contents described above in the fourth or fifth embodiment. The device identification information used to identify the detection setting information is obtainable also through a UPnP-based device discovery process in the eighth embodiment. Thus, the process of identifying the detection setting information in the detection setting table 58 may be performed by using the device identification information obtained through the device discovery process.

In addition, with regard to how to identify detection setting information in the case where a plurality of kinds of detection setting information are associated with a single piece of device identification information, the detection setting used in the detection process is identified in a predetermined priority order (e.g., in a priority order in which “HDMI-CEC” is given the first priority, “HPD or HDCP” the second priority, and “UPnP” the third priority; note that a priority order other than this is also possible). The detection setting table 58 according to such a modification is suitable because it makes it possible to easily determine that detection can be performed by using a UPnP signal if “UPnP is available” in the case where the state is not detectable with any of “HDMI-CEC”, “HPD”, and “HDCP” like a model whose manufacturer is “F” and model number is “FX1” listed at the bottom of the table, for example.

### Ninth Embodiment

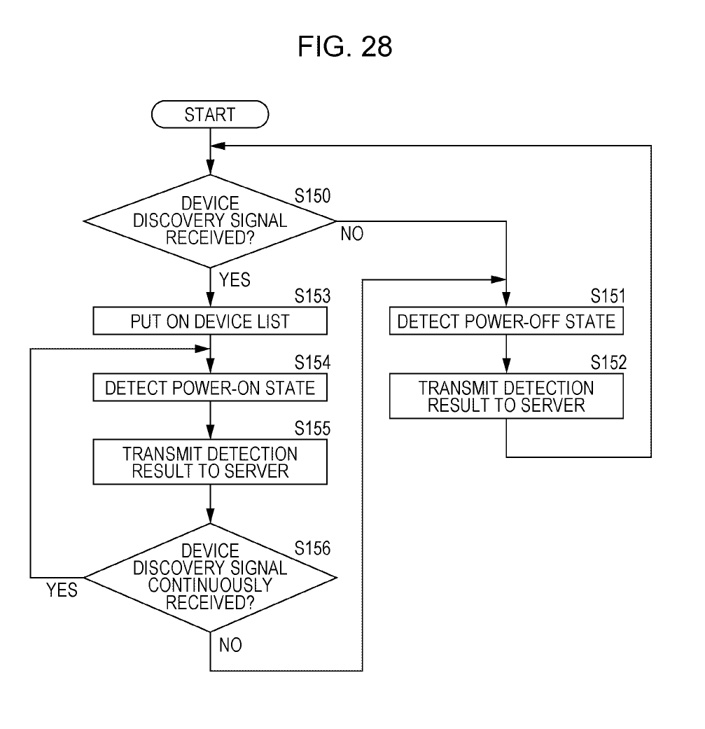

FIG. 28 illustrates a fourteenth flowchart used in an invention according to a ninth embodiment of the present invention. The invention according to the ninth embodiment is characterized in that an output used in detection setup or the like is transmitted over wireless connection (e.g., Bluetooth (registered trademark)). The invention according to the ninth embodiment has configurations such as a basic hardware configuration that are equivalent to those of the first and other embodiments. Thus, the ninth embodiment will be described below by using the same reference sings as those used in the first and other embodiments for the equivalent parts.

The basic contents of the invention according to the ninth embodiment are similar to those of the eighth embodiment described above but wireless communication in the eighth embodiment is replaced with wireless connection. Specifically, the communication terminal device 20 outputs screen information (such as video information) corresponding to content to be displayed on the television device 10 from the external device connection unit 22 to the first connection unit 17a of the television device 10 as in the first to eighth embodiments described above; however, the communication terminal device 20 obtains output signals used in the detection setting identifying process and the detection process via wireless connection. Accordingly, the communication terminal device 20 is wirelessly connected to the wireless connection unit 17d of the television device 10 by using the wireless connection unit 25 (connection means).

To make wireless connection, a connection needs to be established between the connection terminal device 20 and the wireless connection unit 17d of the television device 10. The communication terminal device 20 detects whether the television device 10 is in the power-on state or the power-off state through a wireless connection device discovery process. When a wireless connection is established, the television device 10 transmits a device discovery signal (corresponding to an output signal indicating establishment of a communication connection to the television device 10) informing a communication destination of device identification information such as identification information/configurations of the television device 10. Thus, if the connection destination (the communication terminal device 20) successfully obtains this device discovery signal, the connection destination recognizes the television device 10 as the wireless connection destination and performs a process of putting the television device 10 on a wireless connection destination device list.

After the connection has been established, the communication terminal device 20 determines whether the connection is maintained based on a device discovery signal transmitted from the television device 10 via wireless connection. If the signal from the television device 10 stops, the communication terminal device 20 determines that the television device 10 enters the power-off state. As described above, in the ninth embodiment, the CPU 21 serves as a state detecting means to detect whether the television device 10 (external display device) is in the power-on state or the power-off state on the basis of whether a device discovery signal is obtained. The CPU 21 performs the process of transmitting the detection result to the server device 2 via the wireless communication unit 23 as in the embodiments described above. Accordingly, the detection program P2 of the communication terminal device 20 according to the ninth embodiment includes contents defining that the CPU 21 performs processes indicated by the above-described contents and the fourteenth flowchart or the like to function as a signal obtaining means, a state detecting means, a detection result transmitting means, for example.

Processing contents of S150 to S156 of the fourteenth flowchart in FIG. 28 are equivalent to the flow of the processing of S140 to S146 of the thirteenth flowchart in FIG. 26, and the communication terminal device 20 detects the power-on state or the power-off state on the basis of whether a device discovery signal is obtained. The invention according to the ninth embodiment is suitably applicable to the case where the state of the device is not detectable with the contents described above in the first to eighth embodiments (contents regarding detection via HDMI connection, contents regarding detection via wireless/wired LAN).

Various modifications described in the eighth embodiment are also applicable to the ninth embodiment. For example, as a transmission channel used to transmit screen information, channels compliant with standards such as composite, component, MHL (Mobile High-definition Link), IEEE 1394, VGA (Video Graphics Array), and DVI (Digital Visual Interface) are also usable as well as HDMI. In addition, as in the fourth and fifth embodiments described above, the items of the detection setting table 8, which stores, for each model, detection setting information indicating whether the power-on/off state of the television device 10 is detectable, may further include an item indicating whether power-on/off is detectable based on a device discovery signal over Bluetooth (registered trademark). A configuration may be made to determine whether the state of the device is detectable based on a device discovery signal by using the detection setting table 8 according to such a modification. In this case, in accordance with the fourth embodiment described above or other embodiments, for example, a setting used to detect the state of the device is identified in a priority order of “HDMI-CEC”, “HPD”, “HDCP”, “UPnP”, and “a device discovery signal”. With such a configuration, if “a device discovery signal is available” in the case where the state is not detectable with any of “HDMI-CEC”, “HPD”, “HDCP”, and “UPnP”, it is easily determined that the detection can be performed by using “a device discovery signal”.

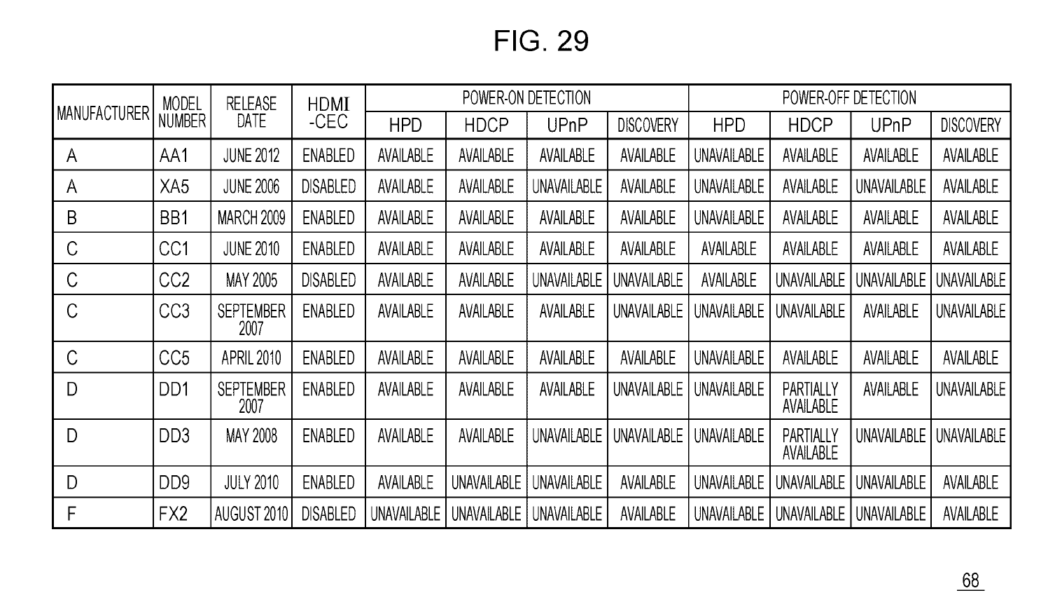

FIG. 29 illustrates an example of a detection setting table 68 according to such a modification of the ninth embodiment. The detection setting table 68 according to this modification additionally includes an item “discovery” for wireless connection (Bluetooth (registered trademark)) at the power-on detection and the power-off detection of the detection setting table 58 illustrated in FIG. 27. Accordingly, the detection setting table 58 according to the modification includes detection setting information for a plurality of kinds of connections or communication schemes such as the HDMI channel, communication (wireless/wired), and wireless connection (includes five kinds of detection setting information in total).

With regard to how to identify certain detection setting information in such a detection setting table 68, the identification is performed in accordance with the contents described above for the detection setting table 58 of FIG. 27 in the eighth embodiment. The device identification information used to identify the detection setting information is obtainable also from the device discovery signal in the ninth embodiment. Thus, the process of identifying the detection setting information in the detection setting table 68 may be performed by using the device identification information obtained from this device discovery signal.

In addition, with regard to how to identify detection setting information in the case where a plurality of kinds of detection setting information are associated with a single piece of device identification information, the detection setting used in the detection process is identified in a predetermined priority order (e.g., in a priority order in which “HDMI-CEC” is given the first priority, “HPD or HDCP” the second priority, “UPnP” the third priority, and “(Bluetooth (registered trademark)) discovery” the fourth priority; note that a priority order other than this is also possible). The detection setting table 68 according to such a modification is suitable because it makes it possible to easily determine that detection can be performed by using a device discovery signal if “discovery is available” in the case where the state is not detectable with any of “HDMI-CEC”, “HPD”, “HDCP”, and “UPnP” like a model whose manufacturer is “F” and model number is “FX2” listed at the bottom of the table, for example. As another example of the detection setting table including the item for the device discovery signal, a table including a four kinds of detection setting information in total, in which “UPnP” is replaced with “discovery” in the detection setting table 58 in FIG. 27, is conceivable.

### Tenth Embodiment

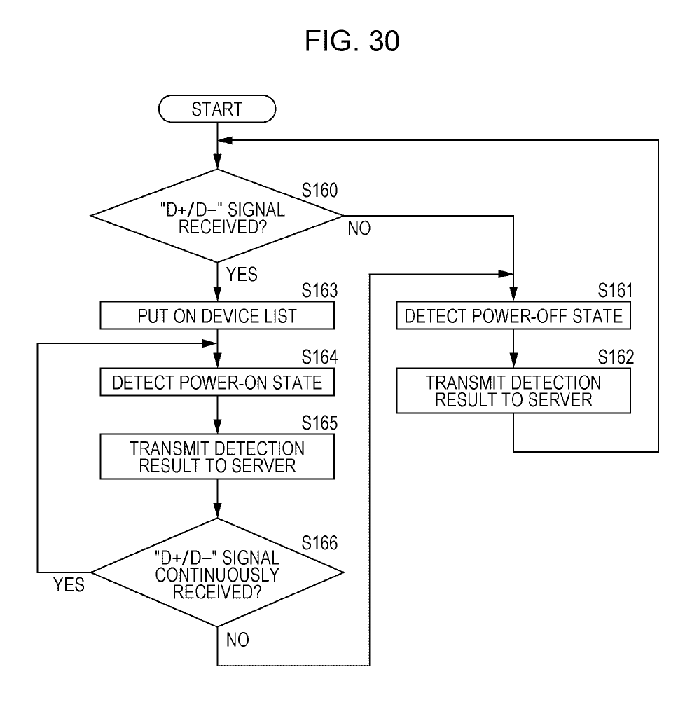

FIG. 30 illustrates a fifteenth flowchart used in an invention according to a tenth embodiment of the present invention. The invention according to the tenth embodiment is characterized in that an output used in detection setup or the like is transmitted via a connection channel based on the USB standard. The invention according to the tenth embodiment has configurations such as a basic hardware configuration that are equivalent to those of the first and other embodiments. Thus, the tenth embodiment will be described below by using the same reference sings as those used in the first and other embodiments for the equivalent parts.

The basic contents of the invention according to the tenth embodiment are similar to those of the eighth and ninth embodiments described above but wireless communication in the eighth embodiment is replaced with USE connection. Specifically, the communication terminal device 20 outputs screen information (such as video information) corresponding to content to be displayed on the television device 10 from the external device connection unit 22 to the first connection unit 17a of the television device 10 as in the first to eighth embodiments described above; however, signals used in the detection setting identifying process and the detection process are transmitted and received via a transmission channel of USB connection.

Accordingly, the communication terminal device 20 is connected, by a USB cable, to the second connection unit 17b of the television device 10 by using the external interface connection unit 24 (connection means). It is assumed in an example of this case that the external interface connection unit 24 of the communication terminal device 20 serves as a USB host and that the second connection unit 17b of the television device 10 serves as a USE device. The USB cable used for USB connection includes a plurality of transmission lines, which include “D+/D−” signal lines.

In USB connection of the above case, it is indicated whether a communication connection to a connection destination is established depending on whether there is a signal transmitted on the “D+/D−” signal line. In this way, the communication terminal device 20 detects the power-on/off state of the television device 10. When there is a signal on the “D+/D−” signal line (corresponding to an output signal indicating establishment of a connection to the television device), the television device 10 is in the power-on state. When there is no signal on the “D+/D−” signal line, the television device 10 is in the power-off state. Thus, the communication terminal device 20 detects the power-on/off state of the television device 10 depending on whether there is a signal on the “D+/D−” signal line and performs a process of transmitting the detection result to the server device 2 via the wireless communication unit 23 as in the embodiments described above. Accordingly, the detection program P2 of the communication terminal device 20 according to the tenth embodiment also defines that the CPU 21 performs processes indicated by the above-described contents and the fifteenth flowchart or the like to function as a signal obtaining means, a state detecting means, and a detection result transmitting means, for example.

In addition, the communication terminal device 20, which is a USB host, is capable of obtaining device identification information, such as model information (vendor ID, product ID) of the television device 10. In the case where commands for the television device 10 are known in advance, the communication terminal device 20 may control the television device 10 via USB connection. Further, a typical scheme for controlling the television device 10 may be standardized in the future, and the communication terminal device 20 may obtain information concerning source switching and a view period of the television device 10 via USB. If these pieces of information are obtainable, a more detailed watch-over can be performed when the system is applied to the watch-over service (for example, no operation for 24 hours), which is preferable.

Processing contents of S160 to S166 of the fifteenth flowchart in FIG. 30 are equivalent to the flow of the processing of S140 to S146 of the thirteenth flowchart in FIG. 26, and the communication terminal device 20 detects the power-on state or the power-off state on the basis of whether there is a signal on the “D+/D−” signal line as described above. The invention according to the tenth embodiment is suitably applicable to the case where the state of the device is not detectable with the contents described above in the first to ninth embodiments (contents regarding detection via HDMI connection, contents regarding detection via wireless/wired LAN, and contents regrading detection using Bluetooth (registered trademark)).

Various modifications described in the eighth and ninth embodiments are also applicable to the tenth embodiment. For example, as a transmission channel used to transmit screen information, channels compliant with standards such as composite, component, MHL (Mobile High-definition Link), IEEE 1394, VGA (Video Graphics Array), and DVI (Digital Visual Interface) are also usable as well as HDMI.

In addition, in the case where the television device 10 includes a function of a USB video card, screen information (video signal) can be transmitted from the communication terminal device 20 via USB. In this case, connection via a channel other than USB (such as HDMI) can be omitted. Further, as in the eighth and ninth embodiments described above, the items of the detection setting table 8 illustrated in FIG. 17, which stores, for each model, detection setting information indicating whether the power-on/off state of the television device 10 is detectable, may further include an item indicating whether power-on/off is detectable based on a signal on the USE “D+/D−” signal line. A configuration may be made to determine whether the state of the device is detectable based on a signal on the “D+/D−” signal line by using the detection setting table 8 according to such a modification. In this case, in accordance with the fourth embodiment described above or other embodiments, for example, a setting used to detect the state of the device is identified in a priority order of “HDMI-CEC”, “HPD”, “HDCP”, “UPnP”, “a device discovery signal”, and “D+/D−”. With such a configuration, if “D+/D− is available” in the case where the state is not detectable with any of “HDMI-CEC”, “HPD”, “HDCP”, “UPnP”, and “a device discovery signal”, it is easily determined that the detection can be performed by using a signal on the “D+/D−” signal line.

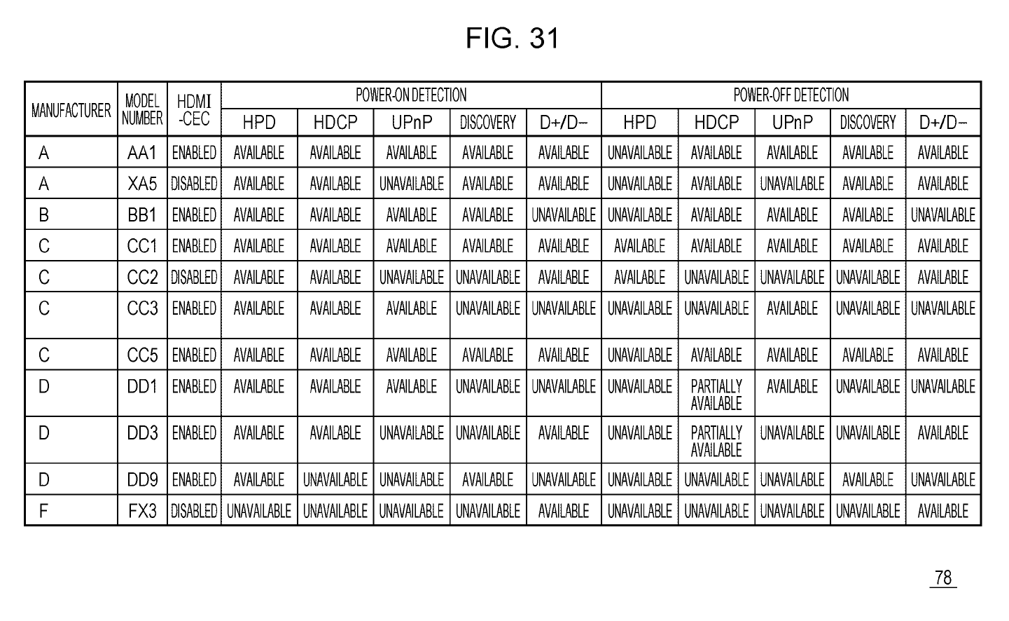

FIG. 31 illustrates an example of a detection setting table 78 according to such a modification of the tenth embodiment. The detection setting table 78 according to this modification additionally includes an item “D+/D−” for USB connection at the power-on detection and the power-off detection of the detection setting table 68 illustrated in FIG. 29. Accordingly, the detection setting table 78 according to the modification includes detection setting information for a plurality of kinds of connections or communication schemes such as the HDMI channel, communication (wireless/wired), and wireless connection (includes six kinds of detection setting information in total).

With regard to how to identify certain detection setting information in such a detection setting table 78, the identification is performed in accordance with the contents described above for the detection setting tables 58 and 68 of FIGS. 27 and 29 in the eighth and ninth embodiments respectively described above. The device identification information used to identify the detection setting information is obtainable via USB connection in the tenth embodiment. Thus, the process of identifying the detection setting information in the detection setting table 78 may be performed by using the device identification information obtained via USB connection.

In addition, with regard to how to identify detection setting information in the case where a plurality of kinds of detection setting information are associated with a single piece of device identification information, the detection setting used in the detection process is identified in a predetermined priority order (e.g., in a priority order in which “HDMI-CEC” is given the first priority, “HPD or HDCP” the second priority, “UPnP” the third priority, “discovery” the fourth priority, and “D+/D−” the fifth priority; note that a priority order other than this is also possible). The detection setting table 68 according to such a modification is suitable because it makes it possible to easily determine that detection can be performed via USB connection if “D+/D− is available” in the case where the state is not detectable with any of “HDMI-CEC”, “HPD”, “HDCP”, “UPnP”, and “discovery” like a model whose manufacturer is “F” and model number is “FX3” listed at the bottom of the table, for example. As other examples of the detection setting table including the item for “D+/D−”, a table including four kinds of detection setting information in total, in which “UPnP” is replaced with “D+/D−” in the detection setting table 58 in FIG. 27, and a table including five kinds of detection setting information in total, in which “UPnP” or “discovery” is replaced with “D+/D−”, are conceivable.

Furthermore, opposite to the configuration described above, the external interface connection unit 24 of the communication terminal device 20 may serve as a USB device, and the second connection unit 17b of the television device 10 may serve as a USB host. In the case of this configuration, the communication terminal device 20 is capable of detecting the power-on/off state of the television device 10 depending on whether there is a signal transmitted on the “D+/D−” signal line. Further, the communication terminal device 20 is capable of detecting the power-on/off state of the television device 10 by checking whether power is supplied from the television device 10 via USB (the television device 10 is in the power-on state when power is supplied and is in the power-off state when power is not supplied).

### Eleventh Embodiment

An invention according to an eleventh embodiment of the present invention is configured such that the communication terminal device and the television device are connected to each other by a video transmission line and a serial cable. As the video channel, channels compliant with standards such as composite, component, MHL (Mobile High-definition Link), IEEE 1394, VGA (Video Graphics Array), and DVI (Digital Visual Interface) are also usable as well as the above-described connection channel compliant with HDMI. On the other hand, as serial connection by the serial cable, connection compliant with a standard such as RS-232C is used. Accordingly, in the eleventh embodiment, connection units compliant with the above-described standards are included in the communication terminal device and the television device.

The communication terminal device detects the power-on/off state of the television device via serial connection. In this case, the communication terminal device needs to grasp all serial commands for the television device 10 in advance. Accordingly, the communication terminal device stores a command table that stores all of such serial commands. The communication terminal device sequentially sends the commands stored in this command table to the television device via serial connection. The communication terminal device determines whether the state of the device is detectable depending on whether a certain response is returned from the television device. In the case where the certain response is not returned even if all the commands are sequentially sent, the connection-destination television device is of a model whose state is undetectable. On the other hand, the television device from which the certain response is returned is of a model whose state is detectable.

Note that the examples of the detection setting tables 58, 68, and 78 respectively described above in the modifications of the eighth, ninth, and tenth embodiments are applicable to the configuration in which connection is established by a serial cable. In this case, the detection setting table further includes an item for the serial cable as in the above-described cases. Further, to allow the communication terminal device to grasp the serial commands, the detection setting table may include various serial commands. In addition, as a method concerning the serial commands other than including the serial commands in the detection setting table, a configuration is preferably made such that a serial command table that stores various serial commands is prepared in the server device and the communication terminal device is configured to be able to download the serial commands when necessary.

### INDUSTRIAL APPLICABILITY

Even if a display device (e.g., a television device) does not have a function of detecting its operation state, a communication terminal device is connected to the display device, detects the operation state of the display device, and notifies a server of the operation state. Thus, the present invention is suitably applicable to various services that use the operation state of the display device.

### REFERENCE SIGNS LIST

| | |
|---|---|
| 1 | device state checking system |
| 2 | server device |
| 2a | MPU |
| 4 | state check program |
| 7 | storage table |
| 8 | detection setting table |
| 10 | television device |
| 14 | control unit |
| 17a | first connection unit |
| 19 | remote control |
| 20 | communication terminal device |
| 21 | CPU |
| 29 | wireless router |
| P2 | detection program |
| K1-K3 | watching person |
| M1 | monitored person |
| H1 | house |
| NW | network |

1-31. (canceled)

32. A device state checking system comprising: a server device; and a communication terminal device, the device state checking system allowing a state of an external display device connectable to the communication terminal device to be checked,
wherein the communication terminal device includes
means for obtaining, from the external display device, device identification information for identifying the external display device, and
means for performing a process of transmitting the obtained device identification information to the server device,
wherein the server device includes
a detection setting table that stores, for each of a plurality of display devices, device identification information of the display device in association with detection setting information related to detection of a state of the display device on the basis of an output from the display device,
means for identifying, in a case where the device identification information transmitted from the communication terminal device is received, detection setting information associated with the received device identification information in the detection setting table, and
means for performing a process of transmitting the identified detection setting information to the communication terminal device, and
wherein the communication terminal device further includes
means for detecting, in a case where the detection setting information transmitted from the server device is received, the state of the external display device in accordance with the received detection setting information on the basis of an output obtained from the external display device.

33. A device state checking system allowing a server device capable of communicating with a communication terminal device connectable to an external display device to check a state of the external display device,
wherein the communication terminal device includes
means for obtaining, from the external display device, device identification information for identifying the external display device,
means for performing a process of transmitting the obtained device identification information to the server device,
means for obtaining an output from the external display device, and
means for performing a process of transmitting the obtained output to the server device,
wherein the server device includes
a detection setting table that stores, for each of a plurality of display devices, device identification information of the display device in association with detection setting information related to detection of a state of the display device on the basis of an output from the display device,
means for identifying, in a case where the device identification information transmitted from the communication terminal device is received, detection setting information associated with the received device identification information in the detection setting table, and
means for detecting, in a case where the output transmitted from the communication terminal device is received, the state of the external display device in accordance with the identified detection setting information on the basis of the received output.

34. A server device capable of checking a state of an external display device by performing communication via a network, comprising:
a detection setting table that stores, for each of a plurality of display devices, device identification information of the display device in association with detection setting information related to detection of a state of the display device on the basis of an output from the display device;
means for performing a process of receiving device identification information for identifying the external display device;
setting identifying means for identifying, in a case where the device identification information is received, detection setting information associated with the received device identification information in the detection setting table;
means for performing a process of transmitting the identified detection setting information to a transmission source of the device identification information;
means for performing, in response to transmission of the device identification information, a process of receiving a detection result obtained by detecting the state of the external display device; and
means for performing, in a case where the detection result is received, a process of storing the received detection result in association with a date/time.

35. A server device capable of checking a state of an external display device by performing communication via a network, comprising:
a detection setting table that stores, for each of a plurality of display devices, device identification information of the display device in association with detection setting information related to detection of a state of the display device on the basis of an output from the display device;
means for performing a process of receiving device identification information for identifying the external display device;
setting identifying means for identifying, in a case where the device identification information is received, detection setting information associated with the received device identification information in the detection setting table; and
means for detecting, in a case where an output from the external display device is received, the state of the external display device in accordance with the identified detection setting information on the basis of the received output.

36. The server device according to claim 34, wherein a plurality of kinds of detection setting information are associated with each piece of device identification information in the detection setting table.

37. The server device according to claim 35, wherein a plurality of kinds of detection setting information are associated with each piece of device identification information in the detection setting table.

38. The server device according to claim 36, wherein the setting identifying means identifies the detection setting information from among the plurality of kinds of detection setting information in accordance with a predetermined priority order.

39. The server device according to claim 37, wherein the setting identifying means identifies the detection setting information from among the plurality of kinds of detection setting information in accordance with a predetermined priority order.

40. A communication terminal device including connection means connectable to an external display device, and communication means capable of performing communication via a network, the communication terminal device comprising:
means for obtaining, from the external display device via the connection means, device identification information for identifying the external display device;
means for performing a process of transmitting, via the communication means, the obtained device identification information to a destination for which an inquiry about detection setting information is made;
means for performing a process of receiving the detection setting information via the communication means in response to the process of transmitting the device identification information;
output obtaining means for obtaining an output from the external display device via the connection means; and
state detecting means for detecting a state of the external display device in accordance with the received detection setting information on the basis of the output obtained by the output obtaining means.

41. A communication terminal device including connection means connectable to an external display device, and communication means capable of performing communication via a network, the communication terminal device comprising:
a detection setting table that stores, for each of a plurality of display devices, device identification information of the display device in association with detection setting information related to detection of a state of the display device on the basis of an output from the display device;
means for obtaining, from the external display device via the connection means, device identification information for identifying the external display device;
setting identifying means for identifying detection setting information associated with the obtained device identification information in the detection setting table;
output obtaining means for obtaining an output from the external display device via the connection means; and
state detecting means for detecting a state of the external display device in accordance with the identified detection setting information on the basis of the output obtained by the output obtaining means.

42. The communication terminal device according to claim 40, further comprising means for performing a process of transmitting a detection result obtained by the state detecting means to an external notification destination via the communication means.

43. The communication terminal device according to claim 41, further comprising means for performing a process of transmitting a detection result obtained by the state detecting means to an external notification destination via the communication means.

44. A communication terminal device including connection means connectable to an external display device, and communication means capable of performing communication via a network, the communication terminal device comprising:
information obtaining means for obtaining, from the external display device via the connection means, at least one of output information following a power-on operation on the external display device and output information following a power-off operation on the external display device; and
detection setup means for performing a process of identifying a detection setting used in detection from among a plurality of detection settings for detecting a state of the external display device on the basis of the output information obtained by the information obtaining means.

45. The communication terminal device according to claim 44, further comprising:
state detecting means for detecting the state of the external display device in accordance with the detection setting identified in the process by the detection setup means, on the basis of the output information obtained by the information obtaining means; and
means for performing a process of transmitting a detection result obtained by the state detecting means to an external notification destination via the communication means.

46. The communication terminal device according to claim 44, further comprising:
storage means for storing screen information corresponding to screen content displayable on the external display device; and
means for performing a process of reading the screen information stored in the storage means and outputting the screen information via the connection means,
wherein the storage means stores user instruction screen information corresponding to screen content including an instruction that prompts a user to perform a power-off operation and perform a power-on operation after a certain amount of time from the power-off operation, and
wherein the detection setup means performs the process of identifying the detection setting in a case where the user instruction screen information is output.

47. The communication terminal device according to claim 45, further comprising:
storage means for storing screen information corresponding to screen content displayable on the external display device; and
means for performing a process of reading the screen information stored in the storage means and outputting the screen information via the connection means,
wherein the storage means stores user instruction screen information corresponding to screen content including an instruction that prompts a user to perform a power-off operation and perform a power-on operation after a certain amount of time from the power-off operation, and
wherein the detection setup means performs the process of identifying the detection setting in a case where the user instruction screen information is output.

48. The communication terminal device according to claim 44, further comprising means for obtaining, from the external display device via the connection means, at least one of an output message indicating that a power-on operation has been performed on the external display device, an output message indicating that a power-off operation has been performed on the external display device, and an output message indicating that an input switching operation has been performed on the external display device,
wherein the detection setup means performs the process of identifying the detection setting in a case where none of the output messages are obtained.

49. The communication terminal device according to claim 45, further comprising means for obtaining, from the external display device via the connection means, at least one of an output message indicating that a power-on operation has been performed on the external display device, an output message indicating that a power-off operation has been performed on the external display device, and an output message indicating that an input switching operation has been performed on the external display device,
wherein the detection setup means performs the process of identifying the detection setting in a case where none of the output messages are obtained.

50. The communication terminal device according to claim 48, wherein the state detecting means detects, in a case where any of the output messages is obtained, the state of the external display device on the basis of the obtained output message.

51. The communication terminal device according to claim 49, wherein the state detecting means detects, in a case where any of the output messages is obtained, the state of the external display device on the basis of the obtained output message.
